(19) United States
(12) Patent Application Publication
(10) Pub. No.: US 2025/0271870 A1
(43) Pub. Date: Aug. 28, 2025

(54) CONTROL METHOD, ROBOT, AND RECORDING MEDIUM

(71) Applicant: Panasonic Intellectual Property Management Co., Ltd., Osaka (JP)

(72) Inventor: Shunsuke KUHARA, Osaka (JP)

(21) Appl. No.: 19/192,730

(22) Filed: Apr. 29, 2025

Related U.S. Application Data
(63) Continuation of application No. PCT/JP2023/035713, filed on Sep. 29, 2023.

(30) Foreign Application Priority Data
Nov. 15, 2022 (JP) 2022-182753

(51) Int. Cl. G05D 1/686; G05D 1/644; G05D 105/70

(52) U.S. Cl. CPC G05D 1/686; G05D 1/644; G05D 2105/70

(57) ABSTRACT

Robot current location information, guidance destination location information, robot travelable area information, and person movable area information are obtained; a person route that is a route for a person from a current location to the location of a guidance destination is calculated, to satisfy a predetermined condition for lightening a burden on the person, based on the robot current location information, the guidance destination location information, and the person movable area information obtained; the person route calculated is compared with the robot travelable area information; and a display format of guidance to the guidance destination, the display format being displayed on a display of the robot, is changed in accordance with a comparison result obtained from the comparing.

### CROSS REFERENCE TO RELATED APPLICATIONS

This is a continuation application of PCT International Application No. PCT/JP2023/035713 filed on Sep. 29, 2023, designating the United States of America, which is based on and claims priority of Japanese Patent Application No. 2022-182753 filed on Nov. 15, 2022. The entire disclosures of the above-identified applications, including the specifications, drawings and claims are incorporated herein by reference in their entirety.

### FIELD

The present disclosure relates to a control method, a robot, and a recording medium.

### BACKGROUND

Patent Literature (PTL) 1, for example, proposes a guide robot that is placed at an event venue or the like and guides a person to a destination.

### CITATION LIST

### Patent Literature

PTL 1: Japanese Unexamined Patent Application Publication No. 2011-000656

### SUMMARY

### Technical Problem

However, there may be areas through which a person can move, but through which the robot cannot travel. In this case, the travelable area is different for the robot and the person, and thus when having the guidance robot guide the person to the destination, the guidance robot may guide the person along a route different from the shortest route for the person.

In such a case, a greater walking burden is placed on the person being guided. If such situations arise repeatedly, the use of guidance robots may drop in the future.

Having been achieved in light of the foregoing circumstances, the present disclosure provides a control method and the like that make it possible to recognize whether guidance along a shortest route for a person is possible.

### Solution to Problem

A control method according to one aspect of the present disclosure is a control method for a robot capable of autonomous movement for guiding a person to a guidance destination. The control method includes: (a) obtaining robot current location information indicating a current location of the robot; (b) obtaining guidance destination location information indicating a location of the guidance destination; (c) obtaining person movable area information indicating an area where the person is capable of moving; (d) obtaining robot travelable area information indicating an area where the robot is capable of traveling; (e) calculating a person route that is a route for the person from the current location to the location of the guidance destination, to satisfy a predetermined condition for reducing a burden on the person, based on the robot current location information, the guidance destination location information, and the person movable area information obtained; (f) comparing the person route calculated with the robot travelable area information; and (g) changing a display format of guidance to the guidance destination, the display format being displayed on a display of the robot, in accordance with a comparison result obtained from the comparing.

Note that these comprehensive or specific aspects may be realized by a system, a method, an integrated circuit, a computer program, or a computer-readable recording medium such as a CD-ROM, or may be implemented by any desired combination of systems, methods, integrated circuits, computer programs, and recording media. The recording medium may also be a non-transitory recording medium.

### Advantageous Effects

According to the control method and the like of the present disclosure, it is possible to recognize whether guidance along a shortest route for a person is possible.

Further advantages and effects of one aspect of the present disclosure will become apparent from the specification and the drawings. While such advantages and/or effects are provided by some embodiments and the features described or illustrated in the specification and the drawings, not all need be provided to achieve one or more of the same features.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of a guidance system including a guidance robot according to Embodiment 1.

FIG. 2 is a block diagram illustrating an example of the hardware configuration of the guidance robot according to Embodiment 1.

FIG. 3 is a block diagram illustrating an example of the functional configuration of the guidance robot according to Embodiment 1.

FIG. 4 is an explanatory diagram illustrating an example of shop information according to Embodiment 1.

FIG. 5 is an explanatory diagram illustrating an example of shop guidance information displayed on a display of the guidance robot according to Embodiment 1.

FIG. 6 is a flowchart illustrating an example of operations by the guidance robot according to Embodiment 1.

FIG. 7 is a flowchart illustrating an example of operations by the guidance robot according to Embodiment 1.

FIG. 8 is a diagram conceptually illustrating a robot shortest route and a person shortest route according to Embodiment 1.

FIG. 9 is a diagram conceptually illustrating a case where a robot shortest route and a person shortest route are different, according to Embodiment 1.

FIG. 10A is a diagram conceptually illustrating a robot shortest route and a person shortest route according to Variation Example 14 of Embodiment 1.

FIG. 10B is a diagram conceptually illustrating a robot shortest route and a person shortest route according to Variation Example 15 of Embodiment 1.

FIG. 11A is a diagram conceptually illustrating a case where a guidance robot according to Modified Example 1 of Embodiment 1 has a travel limit.

FIG. 11B is a diagram conceptually illustrating another case where the guidance robot according to Modified Example 1 of Embodiment 1 has a travel limit.

FIG. 12 is a diagram conceptually illustrating another case where a guidance robot according to Variation Example 1 of Modified Example 1 of Embodiment 1 has a travel limit.

FIG. 13 is a diagram conceptually illustrating another case where a guidance robot according to Variation Example 2 of Modified Example 1 of Embodiment 1 has a travel limit.

FIG. 14 is a diagram conceptually illustrating an example of a case where a guidance robot according to Variation Example 3 of Modified Example 1 of Embodiment 1 guides a person.

FIG. 15 is a diagram conceptually illustrating a robot shortest route and a person shortest route according to Modified Example 2 of Embodiment 1.

FIG. 16 is a diagram conceptually illustrating a robot shortest route and a person shortest route according to Modified Example 3 of Embodiment 1.

FIG. 17A is a diagram conceptually illustrating monitoring processing by a guidance robot according to Modified Example 4 of Embodiment 1.

FIG. 17B is a diagram conceptually illustrating the monitoring processing by the guidance robot according to Modified Example 4 of Embodiment 1.

FIG. 18 is a diagram illustrating an example of a guidance system including a guidance robot according to Embodiment 2.

FIG. 19 is a block diagram illustrating an example of the functional configuration of a cloud according to Embodiment 2.

FIG. 20 is a block diagram illustrating an example of the functional configuration of a reception robot according to Embodiment 2.

FIG. 21 is a block diagram illustrating an example of the functional configuration of a guidance robot according to Embodiment 2.

FIG. 22 is a diagram conceptually illustrating the arrangement of guidance robots in a time period before an event, according to Embodiment 3.

FIG. 23 is a diagram conceptually illustrating the arrangement of guidance robots in a time period after an event, according to Embodiment 3.

### DESCRIPTION OF EMBODIMENTS

Embodiments will be described in detail hereinafter with reference to the drawings.

Note that the following embodiments describe comprehensive or specific examples of the present disclosure. The numerical values, constituent elements, arrangements and shapes, materials, connection states of constituent elements, steps, orders of steps, and the like in the following embodiments are merely examples, and are not intended to limit the present disclosure. Additionally, of the constituent elements in the following embodiments, constituent elements not denoted in the independent claims will be described as optional constituent elements.

Additionally, the drawings are schematic diagrams, and are not necessarily exact illustrations. In the drawings, constituent elements which are the same are given the same reference signs.

### Embodiment 1

A control method for a robot and the like according to the present embodiment will be described hereinafter.

### 1.1 Guidance System

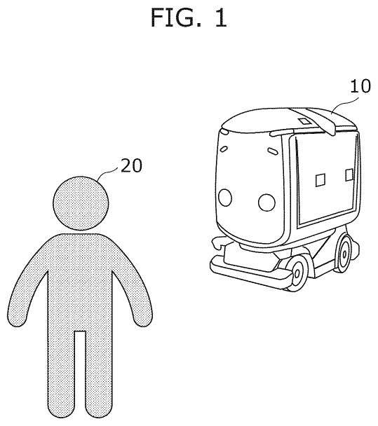

FIG. 1 is a diagram illustrating an example of a guidance system including guidance robot 10 according to the present embodiment.

The guidance system illustrated in FIG. 1 includes guidance robot 10.

Guidance robot 10 is a robot for guiding a person to a guidance destination, and is capable of moving autonomously. Guidance robot 10 may be remotely monitored and remotely controlled by a remote monitoring party over a network (not shown) when necessary. The network is a wireless communication network. The network is, for example, a mobile phone network, a satellite communication network, a wide-area communication network using Wi-Fi (registered trademark), a public line network, or the like, but is not limited thereto.

Person 20 is a person who may use guidance robot 10 to move to a desired guidance destination. When using guidance robot 10, person 20 can move to the guidance destination by having guidance robot 10 guide them thereto.

The present embodiment is described as being constituted by one guidance robot 10 and one person 20, as illustrated in FIG. 1, and one person 20 may use one guidance robot 10 to be guided to the destination. However, the present embodiment is not limited thereto. The configuration may include two or more guidance robots 10 and a plurality of people 20. The following will describe a case where person 20 is a shopping mall customer, for example, and guidance robot 10 is provided in the mall so as to be capable of guiding person 20 to a desired shop.

### 1.2 Guidance Robot 10

Guidance robot 10 is an autonomously-mobile robot for guiding person 20 to a guidance destination, and can be remotely operated, remotely monitored, or both, by a remote monitoring party. Guidance robot 10 includes a display, and causes person 20 to recognize whether guidance along a person shortest route (described later) is possible by a display format of guidance displayed on the display. Note that as long as guidance robot 10 is capable of guiding person 20, guidance robot 10 may have a mechanism enabling luggage of person 20 to be carried, or a mechanism capable of moving one person, such as person 20, on board.

In the present embodiment, guidance robot 10 may guide person 20 to the guidance destination desired by person 20 by person 20 responding to or manipulating the display format of the guidance displayed on the display, or person 20 may move to the guidance destination themselves without guidance.

### 1.2.1 Hardware Configuration of Guidance Robot 10

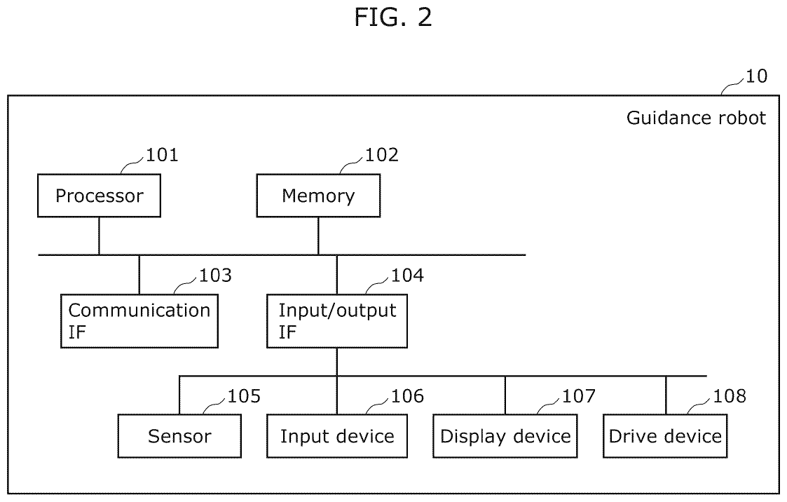

FIG. 2 is a block diagram illustrating an example of the hardware configuration of guidance robot 10 according to the present embodiment.

Guidance robot 10 is implemented by a computer, and includes, for example, processor 101, memory 102, communication IF 103, input/output IF 104, sensor 105, input device 106, display device 107, and drive device 108.

Processor 101 is a computing device that, by executing programs and the like stored in memory 102, performs various processing by controlling communication IF 103, input/output IF 104, sensor 105, input device 106, display device 107, and drive device 108, for example. Processor 101 is, for example, a Central Processing Unit (CPU).

Memory 102 is a storage device that stores programs or data, such as Random Access Memory (RAM), for example. Information subjected to obtainment, calculation, and comparison processing by guidance robot 10 is also stored in memory 102.

Communication IF 103 is a communication interface for wirelessly communicating with external devices such as the cloud, servers, terminals used by remote monitoring parties, other guidance robots 10, or the like, and is communication circuitry, for example.

Input/output IF 104 is an interface that exchanges data among processor 101, memory 102, sensor 105, input device 106, display device 107, drive device 108, and the like. Input/output IF 104 is connected to each of the stated devices. The connection may be wired or wireless, or may be a combination thereof.

Sensor 105 is installed in guidance robot 10, and is controlled by processor 101. Sensor 105 is, for example, a camera, a Light Detection And Ranging (LIDAR) device, a millimeter wave sensor, a speed sensor, an acceleration sensor, an angular velocity sensor, or the like, and senses the conditions around guidance robot 10, the movement state of guidance robot 10, and the like. Sensor 105 may include a Global Positioning System (GPS) device.

Input device 106 is a device serving as a user interface, such as an input button, a touchpad, a touchscreen, or the like, and accepts operations from a user, who is person 20. Note that in addition to accepting tactile operations from person 20, input device 106 may also be configured to accept voice operations and remote operations using a remote controller or the like.

Display device 107 is a display for displaying information that causes person 20 to recognize whether guidance along a person shortest route is possible. Display device 107 may be, for example, a liquid crystal display (LCD) monitor, or may be combined with input device 106 to implement a touchscreen.

Drive device 108 is constituted by a driving body such as a wheel, a motor, an engine, an accelerator, a brake, and the like, and enables guidance robot 10 to move autonomously by being controlled by processor 101.

### 1.2.2 Functional Configuration of Guidance Robot 10

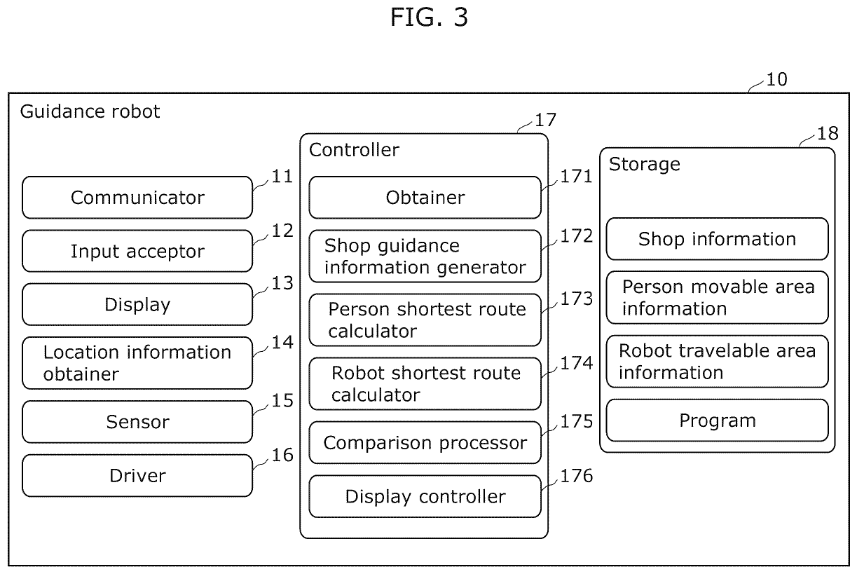

FIG. 3 is a block diagram illustrating an example of the functional configuration of guidance robot 10 according to the present embodiment.

As illustrated in FIG. 3, guidance robot 10 includes communicator 11, input acceptor 12, display 13, location information obtainer 14, sensor 15, and driver 16 as basic functional configurations, and further includes controller 17 and storage 18.

Communicator 11 is a communication interface, for example, and can connect to a network. Communicator 11 is communicably connected to an external device such as the cloud or a server, a terminal used by a remote monitoring party, another guidance robot 10, or the like over a network.

In the present embodiment, communicator 11 is used to exchange information with an external device such as a server, and obtain various types of information stored in storage 18 in advance. Communicator 11 may update the various types of information stored in storage 18 by communicating with the external device periodically or at a predetermined timing.

Input acceptor 12 obtains inputs from person 20. In the present embodiment, input acceptor 12 is a touchscreen, and may be integrated with display 13. In this case, input acceptor 12 may obtain inputs from person 20 by detecting touch operations, flick operations, and the like made by person 20. For example, when a button indicating “start guidance display” is displayed on the screen in a selectable manner, input acceptor 12 can obtain an input to “start” guidance for guiding person 20 to the guidance destination by detecting that person 20 has touched the stated button on the screen. Note that if person 20 is not present near guidance robot 10, input acceptor 12 may hide the buttons on the screen by transitioning to a power saving mode. Input acceptor 12 need not be integrated with display 13. In this case, input acceptor 12 may be a button, a stick, a mouse, or the like, or may be a microphone or the like. If input acceptor 12 is a microphone, voice input from person 20 may be obtained by obtaining voice from person 20.

Display 13 outputs information to person 20 or the like. In the present embodiment, display 13 is a touchscreen, and may be integrated with input acceptor 12. Note that display 13 need not be integrated with input acceptor 12. In this case, display 13 may be a display. Additionally, display 13 may further include a speaker that outputs audio, a projector configuration that outputs information through projection, and a configuration for recognizing gestures.

Location information obtainer 14 obtains location information of guidance robot 10 using sensing information obtained by sensor 15. If the sensing information includes GPS information, location information obtainer 14 may obtain the location information of guidance robot 10 by measuring the location of guidance robot 10 using the GPS information. In addition, if the sensing information is information from a LIDAR device or the like, location information obtainer 14 can obtain the location information of guidance robot 10 by performing self-location estimation processing using the sensing information. An existing Simultaneous Localization and Mapping (SLAM) technique can be used for the self-location estimation processing. Note that the current location information of guidance robot 10 is used as a departure point when guidance robot 10 guides person 20.

Sensor 15 obtains the sensing information from sensor 105, which senses the conditions around guidance robot 10, the movement state of guidance robot 10, and the like.

Driver 16 moves or stops guidance robot 10 by driving drive device 108. Driver 16 is controlled by controller 17.

Controller 17 performs control for causing person 20 to recognize whether guidance along the person shortest route is possible by the display format of the guidance displayed on the display of guidance robot 10. Controller 17 is implemented, for example, by a computer that includes at least a processor, and implements various functions by the processor executing programs stored in memory 102 or storage 18.

As illustrated in FIG. 3, in the present embodiment, controller 17 includes obtainer 171, shop guidance information generator 172, person shortest route calculator 173, robot shortest route calculator 174, comparison processor 175, and display controller 176. Note that with the exception of obtainer 171 and display controller 176, controller 17 can operate in the cloud or on a server, and may operate in the cloud or on the server as appropriate, with the exceptions of the stated elements.

Each element will be described hereinafter.

Obtainer 171 obtains information about a guidance destination, and guidance destination location information indicating the location of the guidance destination.

In the present embodiment, by obtaining shop information stored in storage 18, obtainer 171 can obtain the information about the guidance destination and the guidance destination location information from the shop information obtained. The shop information includes information about the guidance destination used by guidance robot 10 to guide person 20, who is a customer, as well as the guidance destination location information.

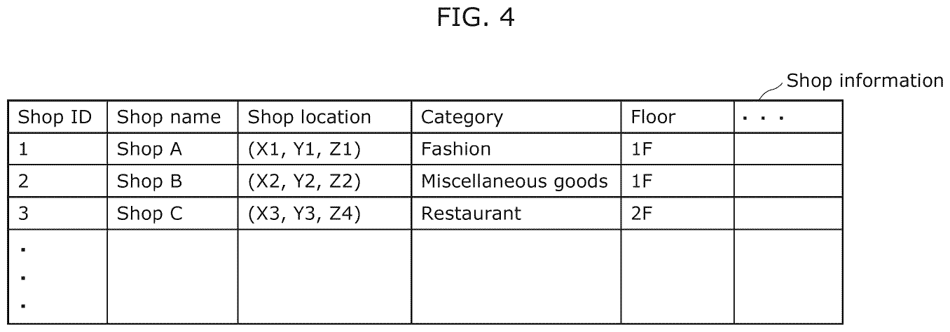

FIG. 4 is an explanatory diagram illustrating an example of the shop information according to the present embodiment.

As illustrated in FIG. 4, the shop information includes at least a list of shop names for each of a plurality of shops, and location information for each of the plurality of shops. The shop information may further include a list of information about the category of each shop, such as fashion, miscellaneous goods, groceries, restaurant, or the like (category information), and information about the floor on which each shop is located, such as the first floor, the second floor, and the like (floor information). Here, the shop name, category information, floor information, and the like are the information about the guidance destination, and the location information of each of the plurality of shops corresponds to the guidance destination location information.

Note that in addition to the category information and the floor information, the information about the guidance destination may include information indicating a shop advertisement, a logo of each of the plurality of shops, and the like. In the example illustrated in FIG. 4, the location information of each of the plurality of shops is three-dimensional coordinates to enable the floor on which the shop is located to be identified as well, but the information is not limited thereto. If the shopping mall has only one floor, the location information of each of the plurality of shops may be expressed as two-dimensional coordinates. Additionally, if GPS information can be obtained within the shopping mall, the location information of each of the plurality of shops may be location information obtained from the GPS information.

As long as the information about the guidance destination is information necessary for guidance robot 10 to guide person 20 to the guidance destination, that information may be any information, and is not limited to including the shop names, category information, floor information, and the like. The information about the guidance destination may further include information indicating entrances and exits, toilets, escalators, elevators, nursing rooms, kids' rooms, parking lots, and the like.

Obtainer 171 also obtains robot current location information indicating the current location of guidance robot 10.

In the present embodiment, as the robot current location information, obtainer 171 obtains location information indicating the current location of guidance robot 10, among the location information of guidance robot 10 obtained by location information obtainer 14.

Obtainer 171 also obtains person movable area information indicating an area where person 20 is capable of moving, and obtains robot travelable area information indicating an area where guidance robot 10 is capable of traveling.

In the present embodiment, obtainer 171 obtains the person movable area information and the robot travelable area information stored in storage 18.

The person movable area information is information indicating an area where a person can move among an overall target area, such as within a shopping mall. The information indicating the area where the person can move may be information expressed using coordinates, or may be information expressed as pathway links along which a person can pass, among pathway links included in pathway link data for the overall target area, generated in the same manner as existing road link data. Note that the person movable area information is created by a manager of the target area or the like and is stored in an external device, and communicator 11 obtains the information from an external device and stores the information in storage 18. The person movable area information may be created from map information indicating the overall target area.

The robot travelable area information is information indicating an area where guidance robot 10 can travel among the overall target area, such as within the shopping mall. The information indicating the area where guidance robot 10 can travel may be information expressed using coordinates, or may be information expressed as pathway links along which a person can pass, among pathway links included in pathway link data for the overall target area, generated in the same manner as existing road link data.

Note that the robot travelable area information is created by a manager of the target area or the like and is stored in an external device, and communicator 11 obtains the information from an external device and stores the information in storage 18. The robot travelable area information may be generated from map information indicating the overall target area, taking into account the performance, status, and operation rules of guidance robot 10. Not being able to climb over steps, not being able to travel in an area having a step, the need to request remote operation by a remote monitoring party due to guidance robot 10 being unable to move autonomously, and the like can be given as examples of the stated performance of guidance robot 10. In this case, that area is generated as a non-travelable area. Being unable to travel in an area for which the remaining battery power is insufficient can be given as an example of the stated status of the guidance robot, and that area is generated as a non-travelable area. Not being able to travel outside a predetermined travel area and, if an assigned area is set for guidance robot 10, not being able to travel outside the assigned area can be given as examples of the stated operation rules. Not being able to travel in the target area because another task, such as a guidance reservation, is scheduled and guidance therefore cannot be provided during that time, but being able to change the travelable area of guidance robot 10 according to the time period, can be given as an example of the stated operation rules. In this manner, taking the operation rules into account, it is possible to operate while limiting some of the travelable areas despite the guidance robot being capable of traveling in those areas in terms of performance.

The robot travelable area information may be generated in a similar format based on the person movable area information. This is because doing so simplifies the processing for comparing the person shortest route with the robot shortest route (described later). This is also because guidance robot 10 is assumed to guide a person. In other words, because a person cannot be guided in an area where only guidance robot 10 can travel, it is preferable to generate the information based on the person movable area information. The robot travelable area information may be generated in what is known as the “Operational Design Domain” (ODD).

The robot travelable area information may be generated for each guidance robot 10. This is because the non-travelable area may differ with respect to the performance and status, depending on the type and model of guidance robot 10. This is also because the travelable area differs for each guidance robot 10 when the travelable area is set according to operations.

Shop guidance information generator 172 generates the shop guidance information based on the shop information stored in storage 18. Shop guidance information generator 172 also generates information for causing person 20 to recognize whether guidance along the person shortest route is possible, and updates the shop guidance information, according to a result of the comparison by comparison processor 175.

The shop guidance information is information displayed on the display of guidance robot 10. In the present embodiment, the shop guidance information includes, in addition to the shop information, information for causing person 20 to recognize whether guidance along the person shortest route is possible. Displaying the shop guidance information on the display of guidance robot 10 in this manner makes it possible to cause person 20 to recognize whether guidance along the person shortest route is possible.

For example, if the result of the comparison by comparison processor 175 indicates that the person shortest route and the robot shortest route (described later) are the same (i.e., if the entire person route is included in the robot travelable area information), shop guidance information generator 172 may add an indication that “guidance robot 10 can guide along person shortest route” to the shop guidance information as the information for causing person 20 to recognize that guidance along the person shortest route is possible. On the other hand, if, for example, the result of the comparison by comparison processor 175 indicates that the person shortest route and the robot shortest route are not the same (i.e., if at least part of the person route is not included in the robot travelable area information), shop guidance information generator 172 may add an indication that “guidance robot 10 can guide along route different from person shortest route” to the shop guidance information.

Note that the content added to the shop guidance information is not limited thereto. For example, if the result of the comparison indicates that the person shortest route and the robot shortest route are not the same, shop guidance information generator 172 may generate information such as that described below as the information, added to the shop guidance information, for causing person 20 to recognize whether guidance along the person shortest route is possible. That is, shop guidance information generator 172 may generate information indicating that guidance robot 10 is capable of guidance to a midway point of the person shortest route where the person shortest route and the robot shortest route diverge (i.e., a boundary point between regions where the person route is and is not included in the robot travelable area information). In this case, shop guidance information generator 172 may specify the midway point where the person shortest route and the robot shortest route diverge. Shop guidance information generator 172 may also generate information indicating that guidance can be continued by converging at a part of the person shortest route where the person shortest route and the robot shortest route overlap again. In this case, shop guidance information generator 172 may specify a midway point where the person shortest route and the robot shortest route diverge (i.e., a boundary point between regions where the person route is and is not included in the robot travelable area information) and a point where the person shortest route and the robot shortest route converge again (i.e., a point where the person route is again included in the robot travelable area information). Shop guidance information generator 172 may also generate information indicating a difference between the distances of the person shortest route and the robot shortest route, or generate information indicating a reason why the robot shortest route is not the same as the person shortest route. Note that the specification of the midway point where the person shortest route and the robot shortest route diverge, the specification of the point where the person shortest route and the robot shortest route converge again, and the calculation of the difference between the distances of the person shortest route and the robot shortest route may be performed by comparison processor 175 (described later).

Other details added to the shop guidance information will be described later, and examples thereof will not be described here.

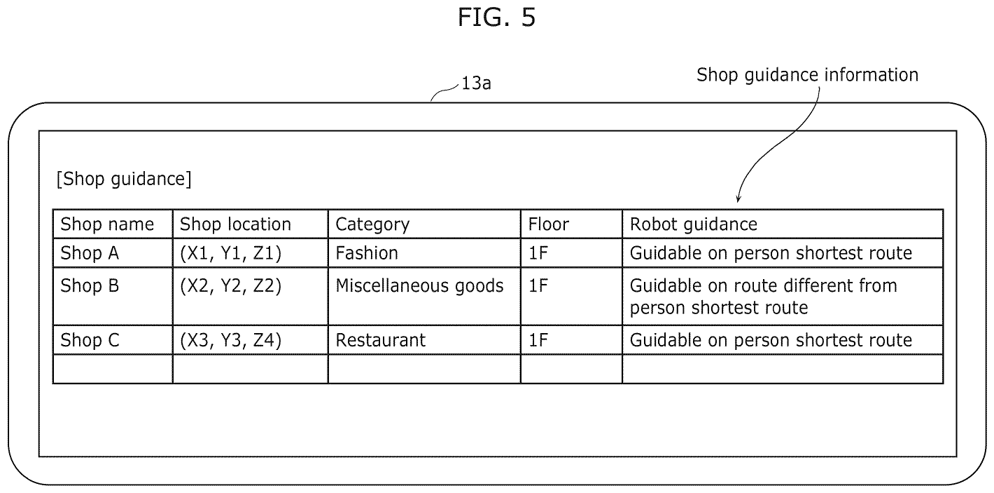

FIG. 5 is an explanatory diagram illustrating an example of the shop guidance information displayed on display 13a of guidance robot 10 according to the present embodiment.

As illustrated in FIG. 5, the shop guidance information includes a list of shop names, location information, category information, and floor information (shop information) for each of the plurality of shops, as well as information indicating on which route guidance robot 10 is capable of guidance (robot guidance information). In other words, in addition to the shop information, the robot guidance information is displayed as the shop guidance information on display 13a of guidance robot 10. The robot guidance information illustrated in FIG. 5 is an example of information for causing person 20 to recognize whether guidance along the person shortest route is possible, and is generated in accordance with the result of the comparison by comparison processor 175. The robot guidance information is not limited to the content illustrated in FIG. 5. The robot guidance information is not limited to being displayed on display 13a in the guidance display format illustrated in FIG. 5, and other display formats may be used as long as person 20 can be caused to recognize whether guidance along the person shortest route is possible. The other details of the robot guidance information and the display format of the guidance will be described later, and examples thereof will therefore not be given here.

Note that shop guidance information generator 172 may generate or update the shop guidance information in response to inputs made by person 20, who is a customer. Shop guidance information generator 172 may generate the shop guidance information illustrated in FIG. 5, for example, in the form of a list organized by category, when person 20 has made an input indicating that they desire a list organized by category.

Additionally, shop guidance information generator 172 may, for example, use the sensing information, such as images, obtained by sensor 15, to estimate the age and sex of person 20, who is a customer, and generate the shop guidance information including information tailored to the estimated age and sex.

Additionally, shop guidance information generator 172 may generate the shop guidance information including only some shops, rather than all the shops included in the obtained shop information. For example, shop guidance information generator 172 may generate the shop guidance information including only ten recommended shops among all the shops included in the obtained shop information.

Person shortest route calculator 173 calculates, as a person route, a person shortest route, which is a shortest route for person 20 from the current location of guidance robot 10 to the location of the guidance destination, to satisfy a predetermined condition for reducing a burden on person 20, based on the robot current location information, the guidance destination location information, and the person movable area information obtained by obtainer 171. In other words, the predetermined condition is the condition that a walking distance of person 20 is the shortest. In the present embodiment, person shortest route calculator 173 generates the shortest route from a departure point to the destination as the person shortest route, using a predetermined shortest route generation algorithm and based on the person movable area information, with the current location of guidance robot 10 serving as the location of the departure point and the location of each shop as the destination. Person shortest route calculator 173 generates the person shortest route for each shop using the location information of each shop obtained by obtainer 171 and the current location information of guidance robot 10. Note that existing algorithms for calculating a shortest route, such as Dijkstra's algorithm, the Bellman-Ford algorithm, and the Floyd-Warshall algorithm, can be used as the shortest route generation algorithm.

Although the predetermined condition is the condition that the walking distance of person 20 is the shortest in the present embodiment, the configuration is not limited thereto. For example, the predetermined condition may be (a) the condition that the grade of the path is low, (b) the condition that there is extensive shade, (c) the condition that the person will not be exposed to rain, (d) the condition that there is little pedestrian traffic, (e) the condition that easy-to-understand roads (boulevards or the like) are traveled, and the like. In other words, person shortest route calculator 173 may calculate not only the person shortest route, but also a person route that satisfies various predetermined conditions. For example, person shortest route calculator 173 calculates a person route that satisfies the condition that there is extensive shade as the predetermined condition, based on the person movable area information, information on the time of day, and shaded area information indicating areas that are shaded.

Robot shortest route calculator 174 calculates, as the robot route, a robot shortest route, which is the shortest route for guidance robot 10 from the current location of guidance robot 10 to the location of the guidance destination, based on the robot current location information, the guidance destination location information, and the robot travelable area information obtained by obtainer 171. In the present embodiment, robot shortest route calculator 174 generates the shortest route from a departure point to the destination as the robot shortest route, using a predetermined shortest route generation algorithm and based on the robot travelable area information, with the current location of guidance robot 10 serving as the location of the departure point and the location of each shop as the destination. Robot shortest route calculator 174 generates the robot shortest route for each shop using the location information of each shop obtained by obtainer 171 and the current location information of guidance robot 10. Note that existing algorithms for calculating a shortest route, such as Dijkstra's algorithm, the Bellman-Ford algorithm, and the Floyd-Warshall algorithm, can be used as the shortest route generation algorithm. It is preferable that the same shortest route generation algorithm be used to calculate the person shortest route and the robot shortest route. This is because calculating the routes using the same algorithm makes it easier to determine whether the calculated routes are the same.

Comparison processor 175 performs processing of comparing the calculated person shortest route with the robot shortest route included in the robot travelable area information (i.e., comparing the person route with the robot travelable area information).

In the present embodiment, comparison processor 175 determines whether the person shortest route calculated by person shortest route calculator 173 and the robot shortest route calculated by robot shortest route calculator 174 are the same (i.e., whether the entire person route is included in the robot travelable area information). Comparison processor 175 transmits the result of the determination to shop guidance information generator 172 as a comparison result.

Note that comparison processor 175 may perform the processing of comparing the person shortest route with the robot shortest route by determining whether the distance of the calculated person shortest route and the distance of the calculated robot shortest route are the same. This is because if the person shortest route and the robot shortest route are different but the distances thereof are the same, the burden on person 20 for walking will be about the same even if person 20 is guided along the robot shortest route, which avoids suppressing the use of the guidance robot.

For example, if comparison processor 175 obtains a comparison result indicating that the person shortest route and the robot shortest route are the same (i.e., that the entire person route is included in the robot travelable area information), that comparison result is transmitted to shop guidance information generator 172. Through this, shop guidance information generator 172 can add an indication that the “robot is capable of guidance along the person shortest route” to the shop guidance information to cause person 20 to recognize whether guidance along the person shortest route is possible. On the other hand, if comparison processor 175 obtains a comparison result indicating that the person shortest route and the robot shortest route are not the same (i.e., that at least part of the person route is not included in the robot travelable area information), that comparison result is transmitted to shop guidance information generator 172. Through this, shop guidance information generator 172 can add an indication that the “robot is capable of guidance along a route different from the person shortest route” to the shop guidance information to cause person 20 to recognize whether guidance along the person shortest route is possible.

Although controller 17 includes robot shortest route calculator 174 in the present embodiment, the configuration is not limited thereto, and robot shortest route calculator 174 may be omitted. In this case, comparison processor 175 performs processing of comparing the person shortest route serving as the calculated person route with the robot travelable area information itself, and determines whether the entire person shortest route is included in the robot travelable area information.

Display controller 176 changes the display format of the guidance to the guidance destination, displayed on the display of guidance robot 10, in accordance with the comparison result obtained from comparison processor 175.

In the present embodiment, display controller 176 may display the shop guidance information generated by shop guidance information generator 172 on the display of guidance robot 10 until comparison processor 175 obtains the comparison result. If comparison processor 175 then obtains a comparison result, display controller 176 may display the shop guidance information generated or updated by shop guidance information generator 172 on the display of guidance robot 10 in accordance with the comparison result from comparison processor 175. For example, if the result of the comparison by comparison processor 175 indicates that the person shortest route and the robot shortest route are the same, an indication that the “robot is capable of guidance along the person shortest route” is displayed on the display of guidance robot 10. On the other hand, if the result of the comparison by comparison processor 175 indicates that the person shortest route and the robot shortest route are not the same, an indication that the “robot is capable of guidance along a route different from the person shortest route” is displayed on the display of guidance robot 10.

In this manner, display controller 176 controls the display format of the guidance to display the information about the guidance destination and the guidance destination location information on the display of guidance robot 10 until a comparison result is obtained by comparison processor 175. Once a comparison result is obtained by comparison processor 175, display controller 176 changes the display format of the guidance so that information causing person 20 to recognize whether guidance along the person shortest route is possible is displayed on the display of guidance robot 10 in accordance with the comparison result from comparison processor 175. Note, however, that the content of the information causing the person to recognize whether guidance along the person shortest route is possible, and the display format of the guidance displayed on the display of guidance robot 10, are not limited to the examples described above.

Specifically, if the comparison result from comparison processor 175 indicates that the person shortest route and the robot shortest route are the same, display controller 176 may change the display format to indicate that guidance along the person shortest route is possible by displaying with highlighting, using a different color compared to when the person shortest route and the robot shortest route are different, or the like. On the other hand, if the comparison result from comparison processor 175 indicates that the person shortest route and the robot shortest route are not the same, display controller 176 may change the display format of the guidance as follows. For example, display controller 176 may change the display format of the guidance displayed on the display of guidance robot 10 to a display format indicating that guidance is possible along the person shortest route to a midway point where the person shortest route and the robot shortest route diverge (i.e., a boundary point between regions where the person route is and is not included in the robot travelable area information). Display controller 176 may also change the display format of the guidance displayed on the display of guidance robot 10 to a display format indicating that guidance can be continued by converging at a part of the person shortest route where the person shortest route and the robot shortest route overlap again (i.e., at a point where the person route is again included in the robot travelable area information). Display controller 176 may also change the display format of the guidance displayed on the display of guidance robot 10 to a display format that indicates a difference between the distances of the person shortest route and the robot shortest route in a recognizable manner. Display controller 176 may also change the display format of the guidance displayed on the display of guidance robot 10 to a display format indicating a reason why the robot shortest route is not the same as the person shortest route (i.e., a reason why part of the person route is not included in the robot travelable area information).

Person shortest route calculator 173 may also calculate a plurality of person routes (including the person shortest route) that satisfy a plurality of predetermined conditions, respectively. In this case, display controller 176 may cause the calculated plurality of person routes to be displayed on the display of guidance robot 10 having added information as to whether guidance by guidance robot 10 is possible for each of the routes. In this case, display controller 176 may cause a recommended point on each of the plurality of person routes to be displayed along with an indication that, for example, (a) the movement distance is the shortest, (b) the road has the lowest grade, (c) the extent of shade is high, (d) the area is not exposed to rain, and the like.

In addition, if guidance robot 10 can only guide person 20 to a midpoint between the current location and the location of the guidance destination for all the calculated person routes, robot shortest route calculator 174 may calculate a robot shortest route on which guidance by guidance robot 10 is possible, and display controller 176 may cause the calculated robot shortest route to be displayed as well. Through this, person 20 can appropriately select whether to have guidance robot 10 guide them to the midpoint of the person route, or to have guidance robot 10 guide to the location of the guidance destination along the robot shortest route. In this case, robot shortest route calculator 174 generates a robot shortest route that satisfies the same predetermined condition as that used when calculating the person shortest route (i.e., the condition that the walking distance for person 20 is the shortest).

The details of the guidance and other examples of the display format of the guidance will be described later, and will therefore not be described here.

Storage 18 is a database storing various types of information, and is implemented by a Hard Disk Drive (HDD), a Solid State Drive (SSD), or the like.

In the present embodiment, storage 18 stores the shop information, the person movable area information, and the robot travelable area information obtained by communicator 11. Storage 18 also stores programs for the processing by controller 17 and communicator 11 to driver 16. The programs stored in storage 18 are, for example, an autonomous movement program, a guidance service program, a processing program, or the like, but are not limited thereto, and may include various programs necessary for controller 17 and the like to perform processing. The autonomous movement program is a program executed to cause guidance robot 10 to move autonomously. The guidance service program is a program executed to cause guidance robot 10 to perform a guidance service by causing guidance robot 10 to perform a series of processing. Note that the series of processing includes, for example, processing for causing guidance robot 10 to move around until a guidance request is made, processing for causing shop guidance to be displayed when a screen displayed on the display of guidance robot 10 is touched by person 20, and the like. The processing programs are programs executed to cause each element of guidance robot 10 to implement a function.

Storage 18 may also store map information including information of the entirety of a target area. Note that the map information may include information mapping the location information of facilities or the like in the target area, or may include information indicating the grades of passages in the target area. The map information may also include information about a non-travelable area where guidance robot 10 is unable to travel, and the information about the non-travelable area may further include factors due to which guidance robot 10 is unable to travel in the non-travelable area, such as steps or the like, for example.

Note that storage 18 may store the person movable area information according to attributes of person 20. The attributes of person 20 are, for example, (a) whether the person uses a wheelchair, (b) whether the person uses a stroller, (c) whether the person is elderly, and the like. For a company, the attributes of person 20 is whether the person is an employee or a visitor. Through this, guidance robot 10 may identify attributes of person 20 by, for example, recognizing an image captured of person 20 by a camera, and use person movable area information based on the identified attributes; or, the stated predetermined condition (e.g., the condition that the walking distance for person 20 is the shortest, the condition that the grade of the road is low, or the like) may be determined according to the identified attributes. For example, if an attribute of person 20 is “elderly”, guidance robot 10 may determine, as the stated predetermined condition, the condition that the grade of the road is low. Likewise, storage 18 may store the robot travelable area information according to the performance of guidance robot 10 or the like.

### 1.3 Operations of Guidance Robot 10

A control method executed by guidance robot 10 configured as described above, i.e., operations of guidance robot 10, will be described hereinafter.

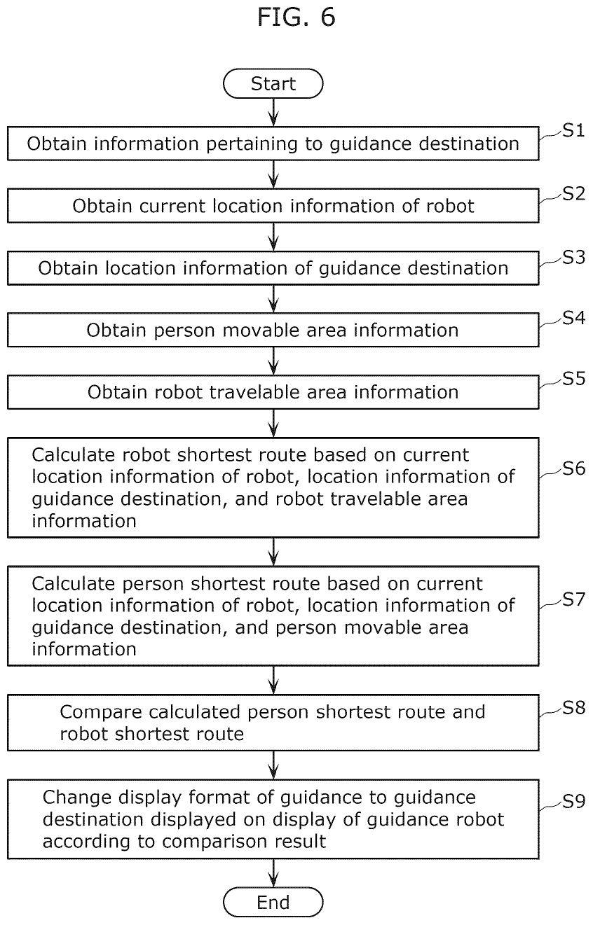

FIG. 6 is a flowchart illustrating a control method for guidance robot 10 according to the present embodiment.

As illustrated in FIG. 6, first, guidance robot 10 obtains information about the guidance destination (S1). In the present embodiment, guidance robot 10 obtains the shop name, category information, floor information, and the like included in the shop information obtained from an external device such as the cloud, a server, or the like and stored, as the information about the guidance destination. Note that step S1 is not required. In this case, it is sufficient for guidance robot 10 to have obtained the information and stored the information in storage 18 in advance.

Next, guidance robot 10 obtains the robot current location information indicating the current location of guidance robot 10 (S2). In the present embodiment, guidance robot 10 is equipped with various sensors, and obtains the location information of guidance robot 10 from sensing information obtained from the various sensors. Guidance robot 10 obtains location information indicating the current location of guidance robot 10, from the obtained location information of guidance robot 10, as the robot current location information.

Next, guidance robot 10 obtains the guidance destination location information (S3). In the present embodiment, as the guidance destination location information, guidance robot 10 obtains the location information of each of the plurality of shops included in the shop information obtained from an external device such as the cloud, a server, or the like and stored.

Next, guidance robot 10 obtains the person movable area information indicating the area where person 20 is capable of moving (S4). In the present embodiment, guidance robot 10 obtains the person movable area information obtained from an external device such as the cloud, a server, or the like and stored.

Next, guidance robot 10 obtains the robot travelable area information indicating an area where guidance robot 10 is capable of traveling (S5). In the present embodiment, guidance robot 10 obtains the robot travelable area information obtained from an external device such as the cloud, a server, or the like and stored.

Next, guidance robot 10 calculates the robot shortest route based on the robot current location information obtained in step S2, the guidance destination location information obtained in step S3, and the robot travelable area information obtained in step S5 (S6). In the present embodiment, guidance robot 10 generates the shortest route from the departure point to the destination as the robot shortest route, based on the robot travelable area information, with the current location of guidance robot 10 serving as the departure point and the location of each shop serving as destinations.

Next, guidance robot 10 calculates the person shortest route to satisfy a predetermined condition for reducing the burden on person 20 based on the robot current location information obtained in step S2, the guidance destination location information obtained in step S3, and the person movable area information obtained in step S4 (S7). In the present embodiment, guidance robot 10 generates the shortest route from the departure point to the destination as the person shortest route, based on the person movable area information, with the current location of guidance robot 10 serving as the departure point and the location of each shop serving as destinations.

Next, guidance robot 10 performs the comparison processing of comparing the person shortest route calculated in step S7 with the robot shortest route calculated in step S6 (S8). In the comparison processing of the present embodiment, guidance robot 10 compares the person shortest route calculated by person shortest route calculator 173 with the robot shortest route calculated by robot shortest route calculator 174, and determines whether the person shortest route and the robot shortest route are the same.

Next, guidance robot 10 changes the display format of the guidance to the guidance destination, displayed on the display of guidance robot 10, in accordance with the comparison result obtained from the comparison processing performed in step S7 (S9). In the present embodiment, guidance robot 10 displays information about the guidance destination and the guidance destination location information on the display of guidance robot 10 until the comparison result is obtained in step S8. Once a comparison result is obtained in step S8, guidance robot 10 changes the display format of the guidance so that information causing person 20 to recognize whether guidance along the person shortest route is possible is displayed on the display of guidance robot 10 in accordance with that comparison result.

### Example of Operations

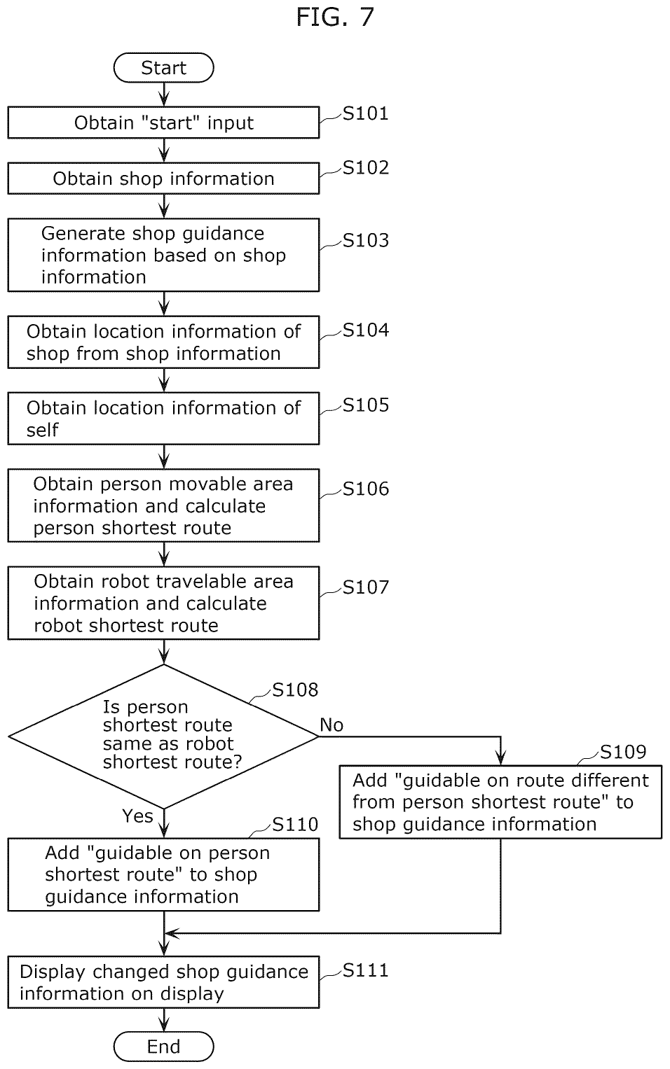

An example of operations of guidance robot 10 according to the present embodiment will be described next with reference to FIG. 7.

The following will describe, as an example, a use case in which when person 20, who is a customer, touches a screen displayed by guidance robot 10, guidance robot 10 generates and displays the shop guidance information, including whether guidance along the person shortest route is possible.

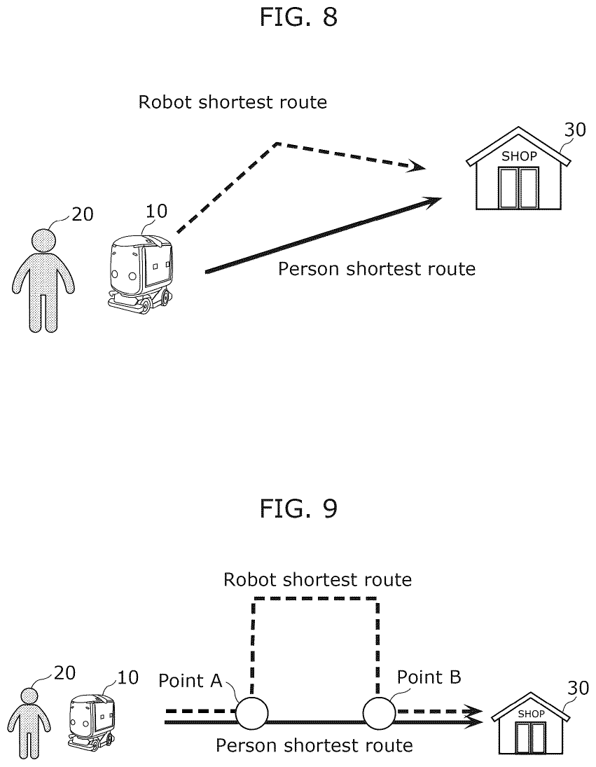

FIG. 7 is a flowchart illustrating an example of operations by guidance robot 10 according to the present embodiment. FIG. 8 is a diagram conceptually illustrating the robot shortest route and the person shortest route according to the present embodiment. FIG. 8 conceptually illustrates the robot shortest route and the person shortest route from the current location of person 20 and guidance robot 10 to shop 30, which is the desired guidance destination for person 20.

First, when the screen displayed on the display of guidance robot 10 is touched by person 20, guidance robot 10 obtains an input to “start” (S101). Note that a “start guidance display” button may be displayed in a selectable manner in the screen displayed on the display of guidance robot 10. Guidance robot 10 can obtain the input to “start” by detecting that the button on the screen has been touched.

Next, guidance robot 10 obtains the shop information including at least the shop name and the location information of each of the plurality of shops (S102). Guidance robot 10 obtains, from storage 18, the shop information including, for example, the shop name and the location information of each of the plurality of shops, as illustrated in FIG. 4, for example.

Next, guidance robot 10 generates the shop guidance information based on the shop information obtained in step S102 (S103). Guidance robot 10 generates the shop guidance information by, for example, creating a list or a table of shop names, shop locations, and the like from the shop information including the shop names and the location information of each of the shops, as illustrated in FIG. 4. Note that creating a list or a table of shop names, shop locations, and the like is an example of generating information on the display format of the guidance that can be displayed in a format recognizable to person 20 on the display of guidance robot 10. If sensing information, such as an image of person 20, can be used, guidance robot 10 may generate the shop guidance information having estimated the age and sex of person 20 and extracting information tailored to the estimated age and sex from the shop information.

Next, guidance robot 10 obtains the location information of a shop from the shop information obtained in step S102 (S104). Guidance robot 10 then obtains the location information of itself (S105). In the present embodiment, guidance robot 10 obtains the robot current location information indicating the current location of guidance robot 10. The robot current location information indicates the current location of guidance robot 10 and the location of person 20 who is a customer and who touched guidance robot 10.

Next, guidance robot 10 obtains the person movable area information indicating the area where person 20 is capable of moving, and calculates the person shortest route (S106). Guidance robot 10 generates the shortest route from a departure point to the destination as the person shortest route, using a predetermined shortest route generation algorithm and based on the person movable area information, with the current location of guidance robot 10 serving as the location of the departure point and the location of each shop as the destination.

Next, guidance robot 10 obtains the robot travelable area information indicating an area where guidance robot 10 is capable of traveling, and calculates the robot shortest route (S107). Guidance robot 10 generates the shortest route from a departure point to the destination as the robot shortest route, using a predetermined shortest route generation algorithm and based on the robot travelable area information, with the current location of guidance robot 10 serving as the location of the departure point and the location of each shop as the destination. Note that it is preferable that the same shortest route generation algorithm be used to calculate the person shortest route and the robot shortest route. This is because calculating the routes using the same algorithm makes it easier to determine whether the calculated routes are the same.

Next, guidance robot 10 compares the person shortest route calculated in step S106 with the robot shortest route calculated in step S107, and determines whether the person shortest route and the robot shortest route are the same (S108).

If it is determined in step S108 that the person shortest route and the robot shortest route are not the same (No in S108), guidance robot 10 adds an indication that “guidance is possible along a route different from the person shortest route” to the shop guidance information (S109).

On the other hand, if it is determined in step S108 that the person shortest route and the robot shortest route are the same (Yes in S108), guidance robot 10 adds an indication that “guidance is possible along the person shortest route” to the shop guidance information (S110). Guidance robot 10 then displays the changed shop guidance information on the display of guidance robot 10 (S111). In this manner, guidance robot 10 updates the display format of the guidance, i.e., the display of the shop guidance information, in accordance with the result of comparing the person shortest route with the robot shortest route.

Note that in step S111, guidance robot 10 may display a map expressed by the map information on the display of guidance robot 10. In this case, guidance robot 10 may determine any desired location specified by person 20 on the displayed map as the guidance destination. Alternatively, when displaying the person shortest route from the current location to the location of the guidance destination on the display of guidance robot 10, guidance robot 10 may accept an operation by person 20 to change the guidance destination to any desired point along the person shortest route.

An indication that “guidance is possible along a route different from the person shortest route” has been described as being displayed on the display of guidance robot 10 when the person shortest route and the robot shortest route are determined not to be the same. However, the configuration is not limited thereto. Any information for causing person 20 to recognize whether guidance along the person shortest route is possible may be displayed on the display of guidance robot 10. An example of a variation on the guidance information and the display format displayed on the display of guidance robot 10 as information for causing person 20 to recognize whether guidance along the person shortest route is possible in cases where the robot shortest route and the person shortest route are different will be described hereinafter with reference to FIG. 9. The processing of the variation example described hereinafter can be implemented by controller 17 of guidance robot 10 executing various programs stored in storage 18.

FIG. 9 is a diagram conceptually illustrating a case where the robot shortest route and the person shortest route are different, according to the present embodiment. FIG. 9 illustrates point A as a midway point where the person shortest route and the robot shortest route diverge, and point B as a point where the person shortest route and the robot shortest route converge again.

### Variation Example 1

When the robot shortest route and the person shortest route are different, guidance robot 10 may display only the person shortest route on the map, or may display both the person shortest route and the robot shortest route on the map, for example. Using such a display format for the guidance enables person 20 to determine whether to have guidance robot 10 guide them to shop 30, taking into account the burden of walking to shop 30.

Note that guidance robot 10 may further display an indication that guidance is possible up to midway along the person shortest route. In this case, guidance robot 10 may specify a midway point where the person shortest route and the robot shortest route diverge (point A) based on the person shortest route and the robot shortest route calculated. This enables guidance robot 10 to display, on the display of guidance robot 10, an indication that guidance is possible from the current location of person 20, which is the current location of guidance robot 10, to the specified point A. Alternatively, when performing guidance to point A, guidance robot 10 may inquire with person 20 as to whether to end or continue the guidance. This is because while being guided by guidance robot 10, person 20 may change their mind and wish to be guided to shop 30 along the robot shortest route instead. Guidance robot 10 may also display a route along which guidance is impossible on the map, such as a map including the robot shortest route from point A to point B illustrated in FIG. 9, or may display an indication that guidance is possible on the robot shortest route, which is a route different from the person shortest route.

The specification of the points and the display of the map can be implemented by controller 17 of guidance robot 10 executing various programs stored in storage 18.

### Variation Example 2

When the robot shortest route and the person shortest route are different, guidance robot 10 may display a difference, such as an advantage the robot shortest route has which the person shortest route does not, in addition to the indication that the person shortest route and the robot shortest route are different.

For example, as the advantage (the difference), guidance robot 10 may display an indicator that a shop such as a convenience store, a vending machine, a facility such as a toilet, or the like is not present on the person shortest route but is present on the robot shortest route. Here, guidance robot 10 may further display an indication that such shops or facilities are not present on the person shortest route in a manner recognizable to person 20. Using such a display format for the guidance enables person 20 to determine whether to have guidance robot 10 guide them to shop 30, taking into account the comparison between the burdens of walking to shop 30 and the stated advantages.

In this case, guidance robot 10 may specify and display shops and facilities that are not present on the person shortest route but are present on the robot shortest route using map information which is stored in storage 18 and which includes information mapping the location information of facilities and the like in the target area. More specifically, first, guidance robot 10 may specify a non-overlapping route where the person shortest route and the robot shortest route do not overlap, such as the route from point A to point B illustrated in FIG. 9. Then, using the map information stored in storage 18, guidance robot 10 may extract information about facilities and the like present on the non-overlapping route for both the person shortest route and the robot shortest route. Guidance robot 10 may then specify facilities that are not present on the non-overlapping route in the person shortest route, but are present on the non-overlapping route in the robot shortest route. This enables guidance robot 10 to display, on the display of guidance robot 10, shops and facilities that are not present on the person shortest route but are present on the robot shortest route, as the stated advantages.

Note that guidance robot 10 may display shops and facilities that are not present on the person shortest route but are present on the robot shortest route, i.e., shops and facilities that are only present on the robot shortest route, on the display of guidance robot 10 in a highlighted display format. Furthermore, guidance robot 10 may obtain information about the current conditions of facilities present on both the person shortest route and the robot shortest route from an external device, such as a server that manages the facilities, through communicator 11, and display that information on the display of guidance robot 10. The information on the current conditions of a facility or the like can include congestion conditions, product inventory conditions, or the like, for example.

The obtainment of the map information stored in storage 18, the specifying of the non-overlapping route, and the specifying of facilities and the like on the person shortest route and the robot shortest route can be implemented by controller 17 of guidance robot 10 executing various programs stored in storage 18.

### Variation Example 3

The examples of advantages of the robot shortest route that are not present in the person shortest route (the differences) are not limited to the examples described above in Variation Example 2.

For example, as the advantage, guidance robot 10 may display an indication that the robot shortest route has a lighter walking burden than the person shortest route. Here, when the person shortest route has a shorter distance but has many slopes or slopes with a steep grade and therefore has a higher walking burden than the robot shortest route, guidance robot 10 may further make a display to that effect. Using such a display format for the guidance enables person 20 to determine whether to have guidance robot 10 guide them to shop 30, taking into account the burdens of walking to shop 30 along the person shortest route and the robot shortest route.

In this case, guidance robot 10 may estimate and display the burden in the non-overlapping route where the person shortest route and the robot shortest route do not overlap using map information which is stored in storage 18 and which includes information indicating the grade of the passage in the target area. More specifically, first, guidance robot 10 may specify a non-overlapping route where the person shortest route and the robot shortest route do not overlap, such as the route from point A to point B illustrated in FIG. 9. Then, using the map information stored in storage 18, guidance robot 10 may extract information about slopes having a grade that is at least a predetermined value present on the non-overlapping route for both the person shortest route and the robot shortest route. Then, using the extracted information about the slope, guidance robot 10 may estimate which of the non-overlapping routes, in the person shortest route and the robot shortest route, has the greater walking burden. Through this, when the non-overlapping route in the robot shortest route has a lighter walking burden than the non-overlapping route in the person shortest route, guidance robot 10 can display an indication that the robot shortest route has a lighter walking burden than the person shortest route on the display of guidance robot 10.

Note that guidance robot 10 can estimate the walking burdens of the person shortest route and the robot shortest route according to, for example, the number of slopes, the grade of the slopes, the distance of the slopes, and the like included in the extracted information about the slopes.

The obtainment of the map information stored in storage 18, the specifying of the non-overlapping route, the extraction of the slope information, the comparison, the estimation of the magnitude of the walking burden, and the like can be implemented by controller 17 of guidance robot 10 executing various programs stored in storage 18.

### Variation Example 4

When the robot shortest route and the person shortest route are different, guidance robot 10 may display a reason why the robot shortest route is different from the person shortest route in addition to the indication that the person shortest route and the robot shortest route are different.

For example, guidance robot 10 may display a reason such as that guidance robot 10 has calculated the robot shortest route in an area where there are no steps which guidance robot 10 can traverse. Using such a display format for the guidance enables person 20 to determine whether to have guidance robot 10 guide them to shop 30, taking that reason into account.

In this case, guidance robot 10 may specify and display the reason why the robot shortest route is different from the person shortest route using the map information stored in storage 18. More specifically, first, the map information may include information about a robot non-travelable area where guidance robot 10 is unable to travel, as well as a factor making it impossible for guidance robot 10 to travel in the robot non-travelable area, such as steps or the like. Guidance robot 10 may then specify a point where the person shortest route and the robot shortest route intersect, such as point A illustrated in FIG. 9. Then, using the map information stored in storage 18, guidance robot 10 may specify the factor that makes it impossible for guidance robot 10 to travel at point A illustrated in FIG. 9, i.e., a boundary point between a robot travelable area and the robot non-travelable area. This enables guidance robot 10 to display, on the display of guidance robot 10, the reason why the robot shortest route is different from the person shortest route, in addition to the indication that the person shortest route and the robot shortest route are different.

Note that the robot travelable area information is generated by a manager of the target area. As such, the manager knows the reason for the robot non-travelable area, and can include the information about the robot non-travelable area and the factors making it impossible for guidance robot 10 to travel in the robot non-travelable area in the map information. In addition, there may be cases where point A illustrated in FIG. 9, i.e., the boundary point between the robot travelable area and the robot non-travelable area, is the only factor that makes travel impossible, or there may be cases where the robot non-travelable area itself is the factor that makes travel impossible. Accordingly, the factors included in the map information may include information indicating whether only the boundary point is not travelable, or the robot non-travelable area itself is not travelable.

The obtainment of the map information stored in storage 18, the specifying of the point at which the person shortest route and the robot shortest route intersect, the specifying of the factor making travel by guidance robot 10 impossible, and the like can be implemented by controller 17 of guidance robot 10 executing various programs stored in storage 18.

### Variation Example 5

When displaying the reason why the robot shortest route is different from the person shortest route, guidance robot 10 may further display an indication that guidance robot 10 is capable of traveling on the person shortest route as long as person 20 provides assistance. In other words, in addition to the reason why the robot shortest route is different from the person shortest route, guidance robot 10 may display an indication that guidance robot 10 can travel on the person shortest route as long as person 20 provides assistance, such as lifting guidance robot 10 at locations where steps are present. Using such a display format for the guidance enables person 20 to determine whether to have guidance robot 10 guide them to shop 30, taking the details of the assistance into account.

In this case, first, in addition to the information about the robot non-travelable area and factors making it impossible for guidance robot 10 to travel in the robot non-travelable area, the map information may further include a method of assistance performed by the person to eliminate the factor. Guidance robot 10 may then specify a point where the person shortest route and the robot shortest route intersect, such as point A illustrated in FIG. 9. Then, using the map information stored in storage 18, guidance robot 10 may specify the factor that makes it impossible for guidance robot 10 to travel at point A illustrated in FIG. 9, i.e., a boundary point between a robot travelable area and the robot non-travelable area, and the method of assistance performed by person 20 to eliminate the factor. This enables guidance robot 10 to display, on the display of guidance robot 10, an indication that guidance robot 10 is capable of traveling on the person shortest route as long as person 20 provides assistance, in addition to the reason why the person shortest route and the robot shortest route are different.

Note that guidance robot 10 may display an indication that guidance robot 10 is capable of traveling on the person shortest route as long as person 20 provides assistance, along with the boundary point where person 20 is to provide assistance, such as point A illustrated in FIG. 9, on the map. Guidance robot 10 may also display an indication that guidance robot 10 is capable of traveling on the person shortest route as long as person 20 provides assistance, along with details of the assistance, such as lifting guidance robot 10 upon reaching the boundary point. Furthermore, person 20 may be notified again of the details of the assistance or the like as guidance robot 10 approaches the boundary point where person 20 is to provide assistance.

In addition to steps, factors that make it impossible for guidance robot 10 to travel include areas spanning different floors, areas of heavy pedestrian traffic, and the like. In these cases, the details of the assistance include assistance in using an elevator, such as pressing open/close buttons or desired floor buttons, assistance in traveling in areas of heavy pedestrian traffic, such as pushing guidance robot 10 by hand, and the like.

### Variation Example 6

Even if the robot shortest route and the person shortest route are different, there are cases where the person shortest route can be moved to guidance robot 10, enabling person 20 to be guided, by changing the operation rules, changing the robot travelable area information, remotely controlling guidance robot 10, or the like.

In such a case, guidance robot 10 may inquire with a remote monitoring party as to whether the person shortest route can be moved to guidance robot 10, enabling person 20 to be guided, by changing the robot travelable area information, remotely controlling guidance robot 10, or the like. Then, if the remote monitoring party approves the inquiry, guidance robot 10 may display the robot shortest route as the same route as the person shortest route, such as by displaying the person shortest route as the robot shortest route. Note that if the remote monitoring party rejects the inquiry, guidance robot 10 may display the robot shortest route that is different from the person shortest route as-is.

More specifically, first, the map information may include information about a robot non-travelable area where guidance robot 10 is unable to travel, and factors making it impossible for guidance robot 10 to travel in the robot non-travelable area. Guidance robot 10 may then specify a point where the person shortest route and the robot shortest route intersect, such as point A illustrated in FIG. 9. Then, using the map information stored in storage 18, guidance robot 10 may specify the factor that makes it impossible for guidance robot 10 to travel at point A illustrated in FIG. 9, i.e., a boundary point between a robot travelable area and the robot non-travelable area.

Guidance robot 10 may then confirm whether the specified factor that makes it impossible for guidance robot 10 to travel is the area being one in which a request for remote operation is required, or whether guidance robot 10 is capable of traveling but is unable to travel for operation reasons. If the result of the confirmation indicates that such is the case, guidance robot 10 may inquire with the remote monitoring party as to whether the person shortest route can be moved to guidance robot 10, enabling person 20 to be guided, by changing the robot travelable area information, remotely controlling guidance robot 10, or the like. If the remote monitoring party approves the request, guidance robot 10 can display the robot shortest route on the display of guidance robot 10 as the same route as the person shortest route.

Note that if the remote monitoring party approves the request, the robot travelable area information that has been changed to enable travel in the area of the person shortest route may be sent to guidance robot 10. In this case, guidance robot 10 may generate the robot shortest route as the same route as the person shortest route. In addition, if the remote monitoring party approves the request, guidance robot 10 may generate the robot shortest route as the same route as the person shortest route after changing the area of the person shortest route to be travelable in the robot travelable area information. This enables guidance robot 10 to display the robot shortest route as the same route as the person shortest route when the remote monitoring party approves the request. In other words, guidance robot 10 can display the person shortest route as the robot shortest route. Although the remote monitoring party makes the determination described above, the configuration is not limited thereto, and a remote system may make the determination automatically instead. For example, the remote system may make the determination automatically according to the conditions of tasks performed by the remote monitoring party. Here, the conditions of the tasks performed by the remote monitoring party include reservation conditions such as remote control requests, for example.

The obtainment of the map information stored in storage 18, the specifying of the point at which the person shortest route and the robot shortest route intersect, the specifying of the factor making travel by guidance robot 10 impossible, the inquiry with the remote monitoring party, and the like can be implemented by controller 17 of guidance robot 10 executing various programs stored in storage 18.

Note that if guidance robot 10 is remotely controlled by the remote monitoring party and can guide person 20 on the same route as the person shortest route, a reservation for remote control by the remote monitoring party may be made. This makes it possible to start remote control immediately upon arriving at a point where remote control is required. Guidance robot 10 can estimate the time of arrival at the point where remote control will be required by dividing the distance to the point where remote control will be required by the speed of guidance robot 10 itself (distance/speed).

In addition, guidance robot 10 may present the following information when inquiring with the remote monitoring party. That is, information may be presented indicating the point where the person shortest route and the robot shortest route intersect, such as point A illustrated in FIG. 9, along with the factor that makes it impossible for guidance robot 10 to travel at that point being an area that requires a request for remote control, or that guidance robot 10 is capable of traveling but is unable to do so for operation reasons.

In addition, guidance robot 10 may further present information about person 20 as assistance for making a determination when inquiring with the remote monitoring party. The information about person 20 may be photographic information of person 20, or may be attribute information of person 20. The remote monitoring party can determine whether person 20 is an elderly person, a child, or a person carrying luggage from the photographic information of person 20, which makes it possible to determine whether the person has difficulty walking. This in turn makes it possible to determine whether to approve inquiries that are received. Note that guidance robot 10 can obtain the photographic information of person 20 from sensor 15, which is, for example, a camera mounted on guidance robot 10. Guidance robot 10 may also estimate the attribute information of person 20, such as their age, from the photographic information of person 20.

### Variation Example 7

When the robot shortest route and the person shortest route are different, guidance robot 10 may display the person shortest route and the robot shortest route in a manner that makes a difference in the distances thereof recognizable, in addition to an indication that the person shortest route and the robot shortest route are different. For example, if the difference between the distances is 50 m, guidance robot 10 may display in indication that the difference between the distances of the person shortest route and the robot shortest route is 50 m. Using such a display format for the guidance enables person 20 to determine whether to have guidance robot 10 guide them to shop 30, taking into account the burden of walking to shop 30.

Note that guidance robot 10 may change the display format in accordance with the difference between the distances of the person shortest route and the robot shortest route.

For example, if the difference between the distances is less than a predetermined value, guidance robot 10 may change to a display format that displays the difference between the distances in a recognizable manner and indicates that “guidance along the robot shortest route” is possible. If the difference between the distances is small, person 20 is likely to select guidance by guidance robot 10, and an indication that “guidance along the robot shortest route” is possible may therefore be displayed. For example, even if the person shortest route and the robot shortest route are different, guidance robot 10 may display an indication that “guidance along the robot shortest route” is possible if the difference between the distances of the person shortest route and the robot shortest route is less than a predetermined value, such as 1 m.

Note that if the difference between the distances is less than the predetermined value, guidance robot 10 may change to a display format that displays an indication that “guidance is possible along the person shortest route”. This is because if the robot shortest route and the person shortest route are different, but the distances of the person shortest route and the robot shortest route are approximately the same, the walking burden on person 20 will be the same as well. Furthermore, because the distances of the person shortest route and the robot shortest route are approximately the same, a “robot shortest route” taken as the person shortest route may be displayed as the “person shortest route”, and an indication that “guidance along the person shortest route is possible” may be displayed. In this case, it is not necessary to change to a display format that displays the difference between the distances. This is because if the person shortest route and the robot shortest route are different, it is necessary to determine whether person 20 will be guided by guidance robot 10. However, changing the display format as described above communicates, to person 20, that the person shortest route and the robot shortest route are the same when such is the case, which makes it possible to reduce the burden of the determination made by person 20.

On the other hand, if the difference between the distances is at least the predetermined value, guidance robot 10 may display the difference between the distances in a recognizable manner, and change to a display format that displays map guidance for the person shortest route. If the difference between the distances is large, person 20 is likely not to select guidance by guidance robot 10, and it is therefore better not to display the indication that “guidance along the robot shortest route” is possible. The map guidance for the person shortest route may then be displayed instead of displaying the “robot shortest route”. This makes it possible to encourage person 20 to travel to the guidance destination on their own without selecting guidance by guidance robot 10.

Additionally, if the difference between the distances is at least the predetermined value, guidance robot 10 may display the difference between the distances in a recognizable manner, and display an indication that “guidance up to midway along the person shortest route” is possible. This makes it possible for guidance robot 10 to guide person 20 to point A in FIG. 9, i.e., the point where the person shortest route and the robot shortest route diverge, while also encouraging the person to travel along the route following the divergence point on their own.

Specifying the point at which the person shortest route and the robot shortest route intersect, calculating the difference between the distances, changing the message or display format according to the difference between the distances, and the like can be implemented by controller 17 of guidance robot 10 executing various programs stored in storage 18.

### Variation Example 8

When the robot shortest route and the person shortest route are different, guidance robot 10 may display, for example, an indication that guidance is possible from the location of guidance robot 10 illustrated in FIG. 9 (the current location), to point A, which is the point where the person shortest route and the robot shortest route diverge. Specifically, guidance robot 10 may change the display format displayed on the display to a display format indicating that guidance along the person shortest route is possible from the current location of guidance robot 10 to the midway point where the person shortest route and the robot shortest route diverge. In this case, guidance robot 10 may use the display format to further display, kin a recognizable manner, an indication that guidance from the current location is not possible after point A illustrated in FIG. 9, i.e., after the divergence point, for example. The display format indicating that guidance is not possible after the divergence point in a recognizable manner may include displaying a map of the route along which guidance is not possible, or displaying map information of the route along which guidance is not possible in a recognizable format.

### Variation Example 9

When the robot shortest route and the person shortest route are different, guidance robot 10 may travel along a non-overlapping route in the robot shortest route, person 20 may move along a non-overlapping route in the person shortest route, guidance robot 10 and person 20 may converge again on a route where the robot shortest route and the person shortest route overlap again, and the guidance of person 20 may continue.

In the example illustrated in FIG. 9, person 20 moves along a route from point A to point B (a non-overlapping route) in the person shortest route, and guidance robot 10 moves along a route from point A to point B (a non-overlapping route) in the robot shortest route. Then, guidance robot 10 may converge with person 20 on a route after point B (a route where the stated routes overlap again) and continue the guidance of person 20. This enables guidance robot 10 to guide person 20 to shop 30, which is the guidance destination desired by person 20, by converging with person 20 again after the travel on the non-overlapping routes.

In this case, as person 20 and guidance robot 10 move along the respective non-overlapping routes, guidance robot 10 may inquire with person 20 as to whether to converge again, and determine whether to converge after traveling along the non-overlapping routes and continue the guidance in accordance with a response to the inquiry. Note that guidance robot 10 may include a convergence point, such as point B illustrated in FIG. 9, when making the inquiry, or may include a time when guidance robot 10 will arrive at the convergence point to converge with the person (a convergence time). Through this, person 20 is notified of the convergence point or the convergence time, and can therefore make a determination in response to the inquiry.

In addition, when the robot shortest route and the person shortest route are different, guidance robot 10 may display an indication that it is possible to converge with person 20 on a route where the robot shortest route and the person shortest route overlap again, and continue the guidance, in a manner recognizable to person 20. Guidance robot 10 may further display, in a recognizable manner, an indication that person 20 moves along a non-overlapping route in the person shortest route and guidance robot 10 travels along a non-overlapping route in the robot shortest route. Using such a display format for the guidance enables person 20 to determine whether to have guidance robot 10 guide them to shop 30, even if there is no guidance partway along the person shortest route (the non-overlapping route). If guidance is requested, guidance robot 10 can guide person 20 to the guidance destination by converging with person 20 again after the travel on the non-overlapping routes.

Here, guidance robot 10 may further display an indication that guidance of person 20 can be continued, along with the convergence point, the distance which person 20 moves along the non-overlapping route in the person shortest route, a standby time for which person 20 will stand by at the convergence point, and the like.

In this case, guidance robot 10 may first specify a point where the person shortest route and the robot shortest route diverge and a point where those routes converge, such as point A and point B illustrated in FIG. 9. Then, guidance robot 10 may calculate a distance from point A to point B illustrated in FIG. 9, i.e., a distance from a divergence point to the convergence point. Guidance robot 10 may then calculate an arrival time of arriving at the convergence point using the calculated distance and the movement speeds of guidance robot 10 and person 20, and calculate a time difference (the standby time).

To reduce the standby time, guidance robot 10 may travel faster when traveling along the non-overlapping route in the robot shortest route than when guidance robot 10 is guiding person 20.

Specifying the divergence point and the convergence point, calculating the distance from the divergence point to the convergence point, calculating the time difference (the standby time), and the like can be implemented by controller 17 of guidance robot 10 executing various programs stored in storage 18.

### Variation Example 10

When the robot shortest route and the person shortest route are different, guidance robot 10 may display a percentage (a distance) of the person shortest route that overlaps with the robot shortest route, in addition to an indication that the person shortest route and the robot shortest route are different.

In the example illustrated in FIG. 9, if the distance of the person shortest route from the current location to shop 30 is 100 m, and the distance from the current location to point A is 30 m, guidance robot 10 may display “30% guidance possible” and “70% guidance impossible” as percentages. In other words, guidance robot 10 may display, as a percentage, the percentage of the total distance of the person shortest route from the departure point to the point up to which guidance robot 10 is capable of guidance, i.e., the distance to the point where the person shortest route and the robot shortest route diverge. Note that when diverging and then converging again, guidance robot 10 may display the percentage for each of a segment up to the divergence point, a segment from the divergence point to the convergence point, and a segment from the convergence point to the destination.

Through this, for example, if it can be confirmed from the displayed percentage that guidance robot 10 is unable to provide guidance for almost all of the total distance of the person shortest route, person 20 can determine that guidance by guidance robot 10 is not needed. In this manner, person 20 can determine whether to have guidance robot 10 guide them to shop 30, taking into account the burden of walking to shop 30 with reference to the displayed percentages.

Note that if the distance from the departure point to a point where guidance robot 10 is capable of guidance is shorter than a predetermined distance, e.g., several meters, guidance robot 10 may skip displaying an indication that guidance robot 10 is capable of guidance until midway.

This is because even if guidance robot 10 is capable of guidance up to midway, when guidance is only possible up to a few meters from the departure point, person 20 may feel that they are, in essence, not being guided by guidance robot 10, and it is therefore better not to provide the display, from the viewpoint of the convenience for person 20.

Specifying the divergence point, calculating the distance, displaying the percentages, controlling whether to perform the display indicating that guidance robot 10 is capable of guidance up to midway, and the like can be implemented by controller 17 of guidance robot 10 executing various programs stored in storage 18.

### Variation Example 11

When the robot shortest route and the person shortest route are different, and the person shortest route from the midway point where the person shortest route and the robot shortest route diverge to the guidance destination (the destination) is easier, guidance robot 10 may display, with priority, an indication that guidance robot 10 is capable of guidance up to partway.

For example, when the person shortest route from point A to shop 30 illustrated in FIG. 9 is easier, guidance robot 10 displays an indication that guidance robot 10 is capable of guidance up to midway along the person shortest route, with priority over displaying the robot shortest route. This enables guidance robot 10 to recommend that guidance robot 10 guide person 20 up to midway along the person shortest route. This makes it possible to lighten the burden on person 20 involved in walking to shop 30, which is the destination, and also makes it possible to shorten the distance over which guidance robot 10 guides person 20 such that guidance robot 10 can move to the next task. Note that guidance robot 10 may display, as a map, an area including a route where guidance robot 10 is not capable of guidance, such as the person shortest route from point A to shop 30 illustrated in FIG. 9.

For example, if the distance from the midway point of the person shortest route where guidance robot 10 is capable of guidance to the destination is not greater than a predetermined value, e.g., when the distance of the person shortest route from point A to shop 30 is about 10 m as illustrated in FIG. 9, guidance robot 10 can determine that the person shortest route is easier.

In addition, if, for example, the number of right and left turns from the midway point of the person shortest route where guidance robot 10 is capable of guidance to the destination is not greater than a predetermined number, e.g., when shop 30 will be reached by going straight at point A illustrated in FIG. 9 and turning right once at the end of that path, guidance robot 10 may determine that the person shortest route is easier.

When the robot shortest route and the person shortest route are different, guidance robot 10 may calculate the person shortest route from the current location to the guidance destination when guiding person 20 according to a selection made by person 20. When it is easier for person 20 to move along the calculated person shortest route, guidance robot 10 may display a recommendation to use the “person shortest route” to person 20. Using such a display format for the guidance enables person 20 to understand that moving along the person shortest route provides a lighter walking burden than continuing to move along the robot shortest route. Accordingly, person 20 can determine whether to have guidance robot 10 continue to guide them to shop 30, taking into account the burden of walking to shop 30.

### Variation Example 12

Referring to the example illustrated in FIG. 9, there are cases where person 20 has made a reservation at shop 30. There are also cases where it is possible to arrive at shop 30 with extra time before the reservation time even if guidance robot 10 guides person 20 along the robot shortest route. In such a case, guidance robot 10 may change to a guidance route that is a route other than the robot shortest route, and guide person 20, within a range that enables person 20 to arrive in time for the reservation. Through this, if shop 30 cannot provide services when person 20 arrives before the reservation time, person 20 can be prompted to visit other shops in the shopping mall. This also makes it possible to reduce the time for which person 20 must wait to receive service.

More specifically, first, guidance robot 10 may obtain reservation information for shop 30, which is the destination, from person 20, who is a customer. Here, guidance robot 10 may obtain the reservation information by having person 20 enter the reservation information, including the reservation time, from s screen displayed on the display of guidance robot 10. Guidance robot 10 may further confirm whether the reservation information obtained by having person 20 enter the information is valid by accessing a system that manages reservation times for shop 30 or the like.

Guidance robot 10 may also obtain a past purchase history or attributes of person 20, who is the customer, predict a shop in which person 20 is likely to be interested based on the obtained past purchase history or attributes, and generate a route which has person 20 stop by the predicted shop as the guidance route. If, for example, guidance robot 10 has obtained attributes indicating that person 20 is a woman in her twenties, guidance robot 10 can predict that person 20 is likely to be interested in fashion-related shops, and generate a route which has person 20 stop by a fashion-related shop as the guidance route. Here, guidance robot 10 may obtain the past purchase history from a membership number of the shopping mall or the like, or may obtain the past purchase history of the online shop from the smartphone of person 20. If sensing information, such as an image of person 20, can be used, guidance robot 10 may obtain the attributes of person 20 by recognizing the face of person 20 from the image and estimating the attributes of person 20, such as their sex, age, and the like.

Guidance robot 10 may also predict, in accordance with the details of the service provided by shop 30 that is the destination of person 20, a shop, facility, or the like where person 20 wishes to stop along the way, and generate a route which has person 20 stop at the predicted shop as the guidance route.

For example, if shop 30 which is the destination of person 20 is a movie theater, the facility where person 20 will wish to stop by along the way is often a toilet, and thus guidance robot 10 may generate a route which has person 20 stop at a toilet as the guidance route. Note that the information of the shops or facilities where person 20 wishes to stop by along the way may be set in advance for each shop 30 serving as a destination of person 20. This makes it possible for guidance robot 10 to predict a shop or facility where person 20 wishes to stop by along the way in accordance with shop 30 serving as the destination of person 20.

In addition, guidance robot 10 may generate a route to stop by a specified shop as the guidance route based on a designation made by person 20 who wishes to stop by the shop or facility.

Additionally, if a guidance route that is a route other than the robot shortest route is generated, guidance robot 10 may change to the generated guidance route and guide person 20 thereon after presenting the generated guidance route to person 20 and obtaining their consent. Note that when presenting the generated guidance route to person 20, guidance robot 10 may further display the time for which person 20 can remain at the shop or facility where they wish to stop by. The time for which person 20 can remain can be calculated by, for example, subtracting the time required for person 20 to move along the guidance route from the reservation time.

### Variation Example 13

The example in which person 20 is guided by changing to a guidance route that is a route other than the shortest route is not limited to the example given in the foregoing Variation Example 12.

Referring to the example illustrated in FIG. 8, even if person 20 has come to shop 30 by moving along the person shortest route or the robot shortest route, they may be unable to receive the service from shop 30 due to shop 30 being crowded with customers or occupied with reservations.

In such a case, guidance robot 10 may change to a guidance route that is a route other than the robot shortest route and guide person 20 such that person 20 arrives at a time slot when service is immediately available. This makes it possible to reduce the time for which person 20 must wait to receive service. This also makes it possible for shop 30 to ease congestion and welcome customers when reservations are available.

More specifically, first, guidance robot 10 may calculate an estimated arrival time for when person 20 moves along the person shortest route or the robot shortest route.

Next, guidance robot 10 may access a system for managing time slots during which service is available immediately based on congestion conditions and the like of shop 30, and determine whether the calculated estimated arrival time corresponds to a time slot during which person 20 can receive service immediately. If the calculated estimated arrival time corresponds to that time slot, guidance robot 10 may display a recommendation that person 20 use the “person shortest route” or the “robot shortest route”. On the other hand, if the calculated estimated arrival time does not correspond to that time slot, guidance robot 10 may generate a guidance route which has person 20 arrive at a time slot in which service is immediately available, and display a recommendation that person 20 use that “guidance route”.

Note that the method for determining whether the calculated estimated arrival time corresponds to a time slot at which person 20 can immediately receive service is not limited to a method for accessing a system that manages time slots during which service is available immediately based on congestion conditions and the like of shop 30. The method may be any one of the following.

For example, guidance robot 10 may access a server for managing reservation information of shop 30 that is the destination of person 20 (the guidance destination), obtain the reservation information, and, based on the reservation information from the time slot corresponding to the estimated arrival time, determine whether the time slot is one in which person 20 can immediately receive service. Additionally, for example, guidance robot 10 may inquire with a system or the like of shop 30 that is the destination of person 20 (the guidance destination), and determine whether the time slot is one in which person 20 can immediately receive service based on the details of a response to the inquiry. Additionally, guidance robot 10 may determine whether the time slot is one in which person 20 can immediately receive service based on current congestion conditions, predicted visitor information, and the like of shop 30 that is the destination of person 20 (the guidance destination), obtained from a system or the like of shop 30. It is assumed here that the system or the like of shop 30 manages the predicted visitor information, and that the current congestion conditions of shop 30 are calculated from images or the like obtained by surveillance cameras or the like installed in shop 30.

Furthermore, if the configuration is such that a reservation with shop 30 serving as the guidance destination can be made through the screen, guidance robot 10 may access a system or the like that manages reservation times of shop 30, and confirm whether a time slot including the calculated estimated arrival time is already occupied by reservation. If the result of the confirmation indicates that the time slot is already occupied by a reservation, guidance robot 10 may inquire with person 20 as to whether to make a reservation at another time slot. If person 20 accepts making a reservation at another time slot, guidance robot 10 may generate a guidance route providing guidance such that person 20 can arrive at the other reserved time slot, and display a recommendation for person 20 to use the “guidance route”.

### Variation Example 14

The foregoing Embodiment 1 and Variation Examples 1 to 13 describe cases where person 20 desires only one shop as a guidance destination. However, the configuration is not limited thereto. Person 20 may desire a plurality of shops as guidance destinations.

If a plurality of guidance destinations have been designated by person 20, guidance robot 10 may determine an order for the guidance destinations such that the robot shortest route is used to travel to the guidance destinations, and preferentially display guidance to person 20 for moving to the plurality of guidance destinations using the “robot shortest route”.

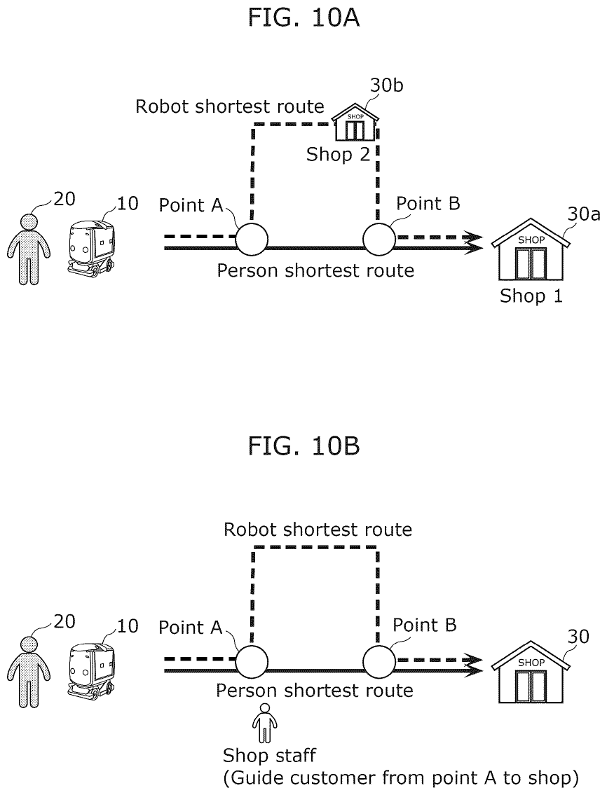

FIG. 10A is a diagram conceptually illustrating a robot shortest route and a person shortest route according to Variation Example 14 of the present embodiment. FIG. 10A illustrates an example of a case where person 20 is a customer of a shopping mall, for example, and two shops 30a and 30b are designated as desired guidance destinations. For example, if shop 30a serves as the first guidance destination and shop 30b serves as the second guidance destination, the person shortest route and the robot shortest route will be different. Accordingly, guidance robot 10 calculates the person shortest route and the robot shortest route with shop 30b as the first guidance destination and shop 30a as the second guidance destination. Through this, the route from the departure point to shop 30b and the route from shop 30b to shop 30a can be the same in both the person shortest route and the robot shortest route, which makes it possible to increase the opportunities to use guidance robot 10 without increasing the walking burden.

### Variation Example 15

If the robot shortest route and the person shortest route are different, it is conceivable that person 20 will give up on going to the shop designated as the guidance destination. From the shop's perspective, the shop wishes for person 20 to visit as a customer, and person 20 giving up on going to the shop results in opportunity loss.

Accordingly, when the robot shortest route calculated by guidance robot 10 is different from the person shortest route, guidance robot 10 may notify the shop, and the shop may be capable of specifying that “guidance robot 10 will provide guidance until partway along the person shortest route, after which shop 30 will guide person 20”. Accordingly, guidance robot 10 can display an indication that “guidance robot 10 will provide guidance until partway along the person shortest route, after which a staff member from shop 30 will guide person 20”.

FIG. 10B is a diagram conceptually illustrating a robot shortest route and a person shortest route according to Variation Example 15 of the present embodiment. FIG. 10B illustrates an example of a case where, when the robot shortest route and the person shortest route are different, a staff member from shop 30, which is the desired guidance destination of person 20, goes to meet person 20 at point A, where the robot shortest route and the person shortest route diverge, and guides person 20 from point A to shop 30. This enables person 20 to travel to shop 30 along the person shortest route and thus be a customer of shop 30, which in turn makes it possible to suppress opportunity loss for shop 30.

Note that guidance robot 10 is not limited to displaying the indication that “guidance robot 10 will provide guidance until partway along the person shortest route, after which a staff member from shop 30 will guide person 20”. Guidance robot 10 may display an indication that “the shop will provide guidance partway”.

In addition, when the robot shortest route calculated by guidance robot 10 is different from the person shortest route, guidance robot 10 may include, in details communicated to the shop, information indicating to which point (e.g., point A) guidance robot 10 can provide guidance, an estimated arrival time at the point to which guidance can be provided (e.g., point A), information indicating an identification number of guidance robot 10, and the like. This makes it possible for shop 30 to guide person 20.

In addition, although the shop has been described as specifying that “guidance robot 10 will provide guidance until partway along the person shortest route, after which shop 30 will guide person 20”, the configuration is not limited thereto. The shop may designate a guidance start point. This is because the shop staff may start guidance at any point in place of guidance robot 10, provided that point is in the robot shortest route between the departure point and the point to which guidance robot 10 can provide guidance (e.g., point A). Through this, guidance robot 10 can display an indication that “guidance robot 10 will guide person 20 until the point on the person shortest route where a staff member from shop 30 will provide guidance, after which the staff member from shop 30 will provide guidance”.

Although a case where a staff member from shop 30 guides person 20 from the guidance start point is described as an example, the configuration is not limited thereto. Another guidance robot 10 capable of traveling on the person shortest route as the robot shortest route may guide person 20 from the guidance start point.

### Variation Example 16

The example in which a staff member from shop 30 guides person 20 from partway along the person shortest route is not limited to the example given in Variation Example 15 above.

If person 20 is a reservation-holding customer of shop 30 indicated in FIG. 10B, and guidance robot 10 guides person 20 on a robot shortest route that is not the person shortest route, person 20 who is the customer of shop 30 will be forced to walk an extra distance, which may lead to shop 30 losing a customer.

Accordingly, if shop 30 that is the guidance destination designated by person 20 (the destination) is a reserved shop of person 20, and the robot shortest route calculated by guidance robot 10 is different from the person shortest route, shop 30 may be notified to make it possible for shop 30 to specify that the robot is to provide guidance up to partway along the person shortest route. Accordingly, guidance robot 10 can display an indication that “guidance robot 10 will provide guidance until partway along the person shortest route, after which a staff member from shop 30 will guide person 20”.

### Variation Example 17

Note that when guiding person 20, guidance robot 10 may, in addition to the information on shop 30 that is the guidance destination, display an advertisement of shop 30. In this case, guidance robot 10 may, when guiding person 20 on the robot shortest route, vary the details of the advertisement of shop 30 that is the guidance destination according to whether the person shortest route and the robot shortest route are different or the same. If the person shortest route and the robot shortest route are different, the time that person 20 walks on the robot shortest route will be longer than the time that person 20 walks on the person shortest route, which makes it possible to add advertisement details, increase the advertisement time, and the like.

In addition, if the person shortest route and the robot shortest route are different, person 20 selecting the robot shortest route over the person shortest route means that person 20 comes to shop 30 regardless of the walking burden, and person 20 may therefore be given benefits, such as points, by shop 30. The details of the benefits may be varied according to the difference between the distances of the person shortest route and the robot shortest route, such as increasing the benefits as the difference between the distances of the person shortest route and the robot shortest route increases.

### Variation Example 18

The foregoing Embodiment 1 and Variation Examples 1 to 17 describe an example where person 20 is a customer of a shopping mall, for example, and guidance robot 10 is provided in the mall so as to be capable of guiding person 20 to a desired shop. However, the configuration is not limited thereto. An example will be described of a case where person 20 is a visitor going to a venue of an event, such as an amusement park, and guidance robot 10 is provided in an area near the venue, such as the nearest station, so as to be capable of guiding person 20 to the desired venue. In other words, Variation Example 18 will describe a case where guidance robot 10 guides person 20, who is a visitor, from a current location to a facility or the like at the event venue. To describe with reference to the example illustrated in FIG. 8, the current location of guidance robot 10 corresponds to an area near the venue, and shop 30 corresponds to a desired facility or the like at the venue.

More specifically, first, guidance robot 10 may search for and specify an event that will be started a predetermined length of time after the current time, using event information stored in storage 18. The event information stored in storage 18 may include information on the event, the venue of the event, the starting time of the event, and the like. Next, guidance robot 10 may specify an event for which (i) the robot shortest route from the robot current location to the venue of the specified event is the same as the person shortest route and (ii) person 20 can be guided to the event by the starting time of the event. Guidance robot 10 may then display guidance for the specified event and an indication that guidance to the venue of the event is possible.

This makes it possible for guidance robot 10 to guide person 20, who is a visitor, from the current location to a facility or the like at the venue of the event.

Note that there are cases where the robot shortest route and the person shortest route from the robot current location to the venue of the specified event are different. In such a case, even if guidance robot 10 guides person 20 along the robot shortest route, information on the event and an indication that guidance to the venue of the event is possible may be displayed when person 20 can be guided to the venue of the event by the starting time of the event. In this case, guidance robot 10 may display an indication that the person shortest route and the robot shortest route are different in a recognizable manner. Furthermore, guidance robot 10 may also display information on estimated arrival times for the case where person 20 is guided along the robot shortest route and the case where person 20 travels to the venue alone along the person shortest route. Such a display format for the guidance makes it possible to cause person 20 to recognize whether they can move along the person shortest route when guided by guidance robot 10, which makes it easier for person 20 to determine whether to have guidance robot 10 guide them to the venue of the event. This is because person 20 will prefer to arrive at the venue earlier when wishing to view the event from a better location.

In addition, person 20 may be capable of specifying a speed at which guidance robot 10 guides person 20 (a guidance speed). Here, the guidance speed may be made selectable from four levels, namely walking slowly, walking normally, walking quickly, and running slowly. This is because in the case of an event, there may be a need to get a good seat or a good location, and there may therefore be a need to arrive at the venue of the event as early as possible.

Guidance robot 10 may also display an indication as to whether guidance is possible by the starting time of the event in accordance with the specified guidance speed. This is because depending on the venue of the event and the starting time, it may be possible to arrive in time if the guidance speed is faster.

Here, for example, guidance robot 10 may display an indication that when guiding the person to the venue of the event, they will not arrive in time if they walk slowly or normally, but they will arrive in time if they walk quickly or run slowly. Note that guidance robot 10 may further display the estimated arrival time at the venue of the event. Guidance robot 10 may also display an indication as to whether guidance is possible by the starting time of the event, and the estimated arrival time, for each guidance speed specified by person 20. Such a display format for the guidance makes it easier for person 20 to determine whether to have guidance robot 10 guide them to the venue of the event.

### 1.4 Effects, Etc

According to the present embodiment as described thus far, even if there is a non-travelable area due to the performance or the like of guidance robot 10, and person 20 and guidance robot 10 have different travelable areas, guidance robot 10 calculates the person shortest route in addition to its own shortest route. Guidance robot 10 then displays guidance in a display format that causes person 20 to recognize whether guidance is possible along the person shortest route. This makes it possible to cause person 20 to recognize whether they can be guided along the person shortest route, which makes it easier for person 20 to determine whether to have guidance robot 10 guide them to the guidance destination taking into account the burden on person 20 for walking to the guidance destination.

### Modified Example 1

The foregoing Embodiment 1 and Variation Examples 1 to 18 describe guidance robot 10 as calculating the robot shortest route and person shortest route, and displaying guidance in a display format according to the comparison result, under the assumption that guidance to the guidance destination is possible. However, the configuration is not limited thereto.

For example, when guidance such as shop 30 on the second floor is displayed by guidance robot 10 that is only capable of guidance on the first floor, guidance robot 10 can display the guidance but cannot move to the second floor. Accordingly, if the person shortest route indicates “escalator entrance-escalator-2F shop”, guidance robot 10 may display an indication that guidance is possible to the point where the escalator is located as a point at the boundary of the robot travelable area (a travel limit point).

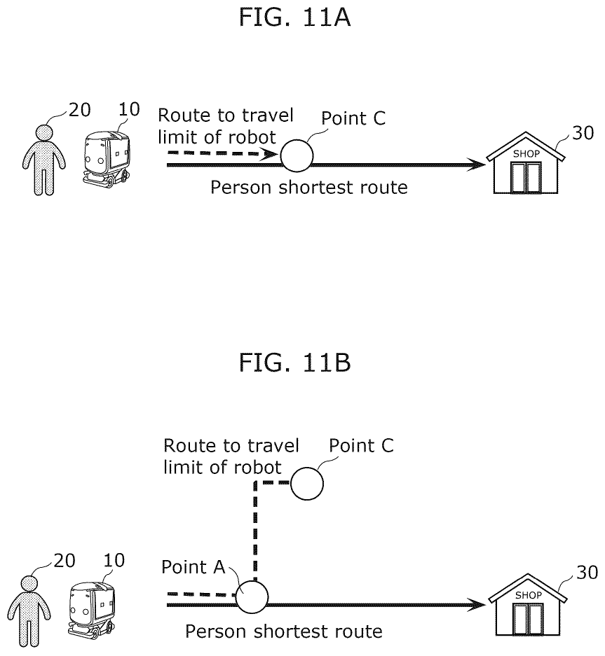

FIG. 11A is a diagram conceptually illustrating a case where guidance robot 10 according to Modified Example 1 of the present embodiment has a travel limit. A travel limit point of guidance robot 10 is indicated as point C in FIG. 11A. In this case, the robot shortest route and the person shortest route to point C are the same, and thus guidance robot 10 may display an indication that guidance to point C is possible along the person shortest route.

Specifically, first, assume that guidance robot 10 has determined that guidance robot 10 is unable to travel to the location of the guidance destination based on the robot current location information, the guidance destination location information, and the robot travelable area information obtained. In this case, of the route between the current location of guidance robot 10 and the location of the guidance destination, guidance robot 10 may calculate the shortest route from that current location to the travel limit point, which is the point up to which guidance robot 10 is capable of traveling, as the robot shortest route. Next, guidance robot 10 compares the calculated robot shortest route with the person shortest route, and obtains a comparison result indicating (i) that guidance robot 10 is unable to travel to the location of the guidance destination and (ii) a boundary point, in the person shortest route, where overlap between the robot shortest route and the person shortest route ends. Next, guidance robot 10 may change the display format displayed on the display to a display format indicating that guidance is possible from the current location to the boundary point in the person shortest route. Note that guidance robot 10 is not limited to displaying an indication that guidance is possible to the travel limit point, and may display an indication that guidance is not possible after the travel limit point. This makes it possible for guidance robot 10 to cause person 20 to recognize whether guidance to the travel limit point along the person shortest route is possible, which makes it easier for person 20 to determine whether to have guidance robot 10 guide them to the travel limit point, which is midway to the guidance destination.

Note that if it is determined that guidance robot 10 is incapable of traveling to the location of the guidance destination, guidance robot 10 may skip calculating the robot shortest route. In this case, of the calculated person shortest route, guidance robot 10 may follow the person shortest route from the departure point, specify the location of intersection with the boundary between the person shortest route and the robot travelable area, and be capable of guidance to that location.

FIG. 11B is a diagram conceptually illustrating another example of a case where guidance robot 10 according to Modified Example 1 of the present embodiment has a travel limit. A travel limit point of guidance robot 10 is indicated as point C in FIG. 11B as well. As illustrated in FIG. 11B, the person shortest route and the robot shortest route are different, and thus guidance robot 10 may skip displaying an indication that guidance to point C is possible, and may display an indication that guidance to point A is possible along the person shortest route.

### Variation Example 1

There are cases where guidance robot 10 is only capable of guidance to the travel limit point, but another guidance robot 10 is capable of guidance from the travel limit point to the guidance destination. This case will be described as Variation Example 1.

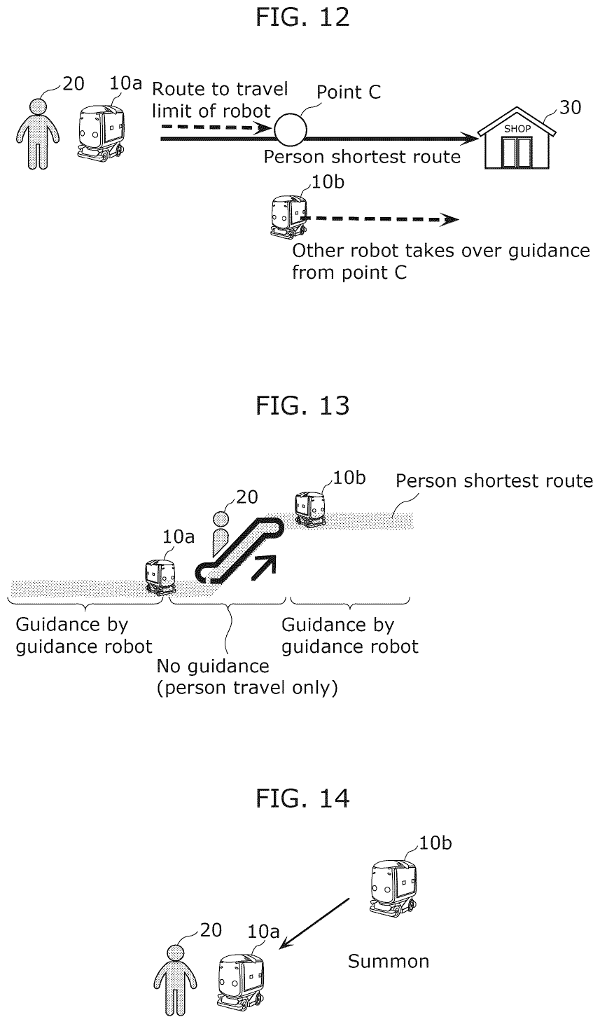

FIG. 12 is a diagram conceptually illustrating a case where guidance robot 10a according to Variation Example 1 of Modified Example 1 has a travel limit. The travel limit point of guidance robot 10a is indicated as point C in FIG. 12, and another robot that takes over guidance from point C is indicated as guidance robot 10b.

As illustrated in FIG. 12, if guidance robot 10b is capable of taking over the guidance from point C, guidance robot 10a may display an indication to that effect.

In this case, it is sufficient for information about the other robot, such as a communication address, travelable area information, and the like, to be stored in storage 18 of guidance robot 10a. Guidance robot 10a generates a robot shortest route from point C to the guidance destination for each other robot, and specifies guidance robot 10b, which is the other robot, for which the person shortest route and the robot shortest route from point C to the guidance destination are the same. Guidance robot 10a may inquire whether guidance robot 10b can take over the guidance, and upon receiving information indicating approval from guidance robot 10b, may display an indication that “guidance is possible along the person shortest route”. The inquiry preferably includes point C, the arrival time at point C, the guidance destination, and the like. Guidance robot 10a may also display an indication that guidance will be handed over to guidance robot 10b partway through the guidance.

More specifically, assume that guidance robot 10a has obtained a comparison result indicating (i) that travel to the location of the guidance destination is not possible and (ii) a boundary point, in the person shortest route, where overlap between the robot shortest route and the person shortest route ends. In this case, guidance robot 10a may obtain the robot current location information and the robot travelable area information for each of one or more other robots different from guidance robot 10a. Guidance robot 10a may then calculate another robot shortest route, which is the shortest route from the boundary point to the location of the guidance destination, for each of the one or more other robots, based on the robot current location information and the robot travelable area information obtained for each of the one or more other robots and the guidance destination location information. Next, guidance robot 10a may specify another robot having another robot shortest route that, among the other robot shortest routes, overlaps with the person shortest route from the boundary point to the location of the guidance destination (guidance robot 10b). Then, guidance robot 10a may change the display format displayed on the display to a display format indicating that guidance robot 10a is capable of guidance from the current location to the boundary point along the person shortest route, and that the specified guidance robot 10b is capable of guidance from the boundary point to the location of the guidance destination.

Through this, even if guidance robot 10a has a travel limit point, guidance robot 10b can take over the guidance, which makes it possible to display an indication that person 20 can be guided to shop 30, which is the desired guidance destination for person 20, along the person shortest route.

Note that the entity that takes over the guidance from the travel limit point of guidance robot 10a is not limited to another robot such as guidance robot 10b. The entity may be a staff member of shop 30 serving as the guidance destination, as described in Variation Example 15 according to Embodiment 1, or may be a person, notified by guidance robot 10a, who is capable of guidance.

In Variation Example 1, guidance robot 10b takes over the guidance from the travel limit point, but the configuration is not limited thereto, and guidance robot 10b may take over the guidance at any desired point between the current location and the travel limit point. Through this, if, for example, another task is scheduled for guidance robot 10a, the guidance can be taken over by guidance robot 10b from guidance robot 10a at an early timing to ensure guidance robot 10a will be in time for the other scheduled task. Additionally, if a plurality of guidance robots 10 are arranged in a well-balanced manner in a predetermined area, a situation where the arrangement of the plurality of guidance robots 10 becomes unbalanced due to a specific guidance robot 10a among the plurality of guidance robots 10 perform guidance for a long distance can be suppressed.

### Variation Example 2

Variation Example 1 according to Modified Example 1 describes a case where guidance robot 10 is only capable of guidance to the travel limit point, and another guidance robot 10 takes over the guidance from the travel limit point to the guidance destination. However, the configuration is not limited thereto. Handing over the guidance is possible if person 20 is able to recognize the other guidance robot 10 which is to take over the guidance, and thus the location at which the guidance by guidance robot 10 ends need not be the same as the location at which the guidance is started by the other guidance robot 10 which takes over the guidance. This case will be described as Variation Example 2.

FIG. 13 is a diagram conceptually illustrating a case where guidance robot 10a according to Variation Example 2 of Modified Example 1 has a travel limit. FIG. 13 illustrates an example of a case where guidance robot 10a performs guidance to an escalator entrance, which is the travel limit point, after which person 20 then travels on the escalator alone, and guidance robot 10b then takes over the guidance from the point at which person 20 steps off the escalator. As illustrated in FIG. 13, if guidance robot 10b is capable of taking over the guidance, guidance robot 10a may display an indication to that effect, and display the location at which guidance robot 10a ends the guidance and a location at which guidance robot 10b takes over and starts the guidance. Although guidance robot 10a may display the location at which the guidance ends and the location at which guidance robot 10b takes over and starts guidance at any timing, this display may be made, for example, before guidance robot 10a begins the guidance, immediately before guidance robot 10a ends the guidance, immediately after guidance robot 10a ends the guidance, or the like.

More specifically, assume that guidance robot 10a has obtained a comparison result indicating (i) that travel to the location of the guidance destination is not possible and (ii) a boundary point, in the person shortest route, where overlap between the robot shortest route and the person shortest route ends. In this case, guidance robot 10a may further obtain the robot current location information and the robot travelable area information for each of one or more other robots different from guidance robot 10a. Guidance robot 10a may then calculate another robot shortest route, which is the shortest route from a location within a predetermined range from the boundary point to the location of the guidance destination, for each of the one or more other robots, based on the robot current location information and the robot travelable area information obtained for each of the one or more other robots and the guidance destination location information. Next, guidance robot 10a may specify a takeover robot, which is another robot having another robot shortest route that, among the other robot shortest routes, overlaps with the person shortest route from the location within a predetermined range from the boundary point to the location of the guidance destination (guidance robot 10b). Then, guidance robot 10a may change the display format displayed on the display as follows. The display format may be changed to indicate that guidance robot 10a is capable of guidance from the current location to the boundary point along the person shortest route, that the specified guidance robot 10b is capable of guidance to the location of the guidance destination from the location that is within a predetermined range, and the location where guidance robot 10b will start the guidance.

Through this, even if guidance robot 10a has a travel limit point, guidance robot 10b can take over the guidance, which makes it possible to display an indication that person 20 can be guided to shop 30, which is the desired guidance destination for person 20, along the person shortest route.

### Variation Example 3

Variation Examples 1 and 2 according to Modified Example 1 describe cases where guidance robot 10 is only capable of guidance to the travel limit point, and another guidance robot 10 takes over the guidance to the guidance destination. However, the configuration is not limited thereto.

The other guidance robot 10 may provide guidance from the departure point to the guidance destination instead of guidance robot 10. In other words, regardless of whether guidance robot 10 has a travel limit point, if guidance is not possible on the person shortest route (that is, if the entire person route is not included in the robot travelable area information), another guidance robot 10 capable of guidance along the person shortest route may provide the guidance instead. In such a case, guidance robot 10 can display information to person 20 to have the other guidance robot 10 guide them.

FIG. 14 is a diagram conceptually illustrating an example of a case where guidance robot 10b according to Variation Example 3 of Modified Example 1 guides person 20. FIG. 14 illustrates an example of a case where guidance robot 10b is summoned to the departure point of guidance robot 10a, and guides person 20 instead of guidance robot 10a.

As illustrated in FIG. 14, if guidance robot 10b is capable of taking over guidance from the departure point, guidance robot 10a may display an indication that guidance is possible along the person shortest route. In this case, guidance robot 10 may display an indication that guidance is possible along the person shortest route by guidance robot 10b being summoned, and may further display the time until the summoned guidance robot 10b arrives and guidance can be started (a waiting time).

More specifically, if a comparison result indicating that the person shortest route and the robot shortest route are not the same is obtained, guidance robot 10a may further obtain robot current location information and robot travelable area information for each of one or more other guidance robots different from guidance robot 10a. Then, based on the robot current location information and the robot travelable area information for each of the one or more other guidance robots, and the guidance destination location information, guidance robot 10a may calculate another robot shortest route, which is the shortest route from the current location to the location of the guidance destination, for each of the one or more other guidance robots. Next, guidance robot 10a may specify a substitute robot, which is another guidance robot 10b for which the other robot shortest route, among the other robot shortest routes, is the same route as the person shortest route, and may summon guidance robot 10b specified to the current location. Next, guidance robot 10a may change the display format displayed on the display to a display format indicating that guidance robot 10b is capable of guidance from the current location to the location of the guidance destination along the person shortest route. Note that in this case, it is sufficient for information about the other robot, such as location information of the other robot, a communication address, travelable area information, conditions of tasks of the other robot, and the like, to be stored in storage 18 of guidance robot 10a.

In this manner, if the robot shortest route and the person shortest route are different, guidance robot 10a may search for another guidance robot 10 nearby, and specify and summon the other guidance robot 10b capable of guiding person 20 along the person shortest route.

Accordingly, when the robot shortest route and the person shortest route are different, guidance robot 10a can display an indication that person 20 can be guided to the guidance destination desired by person 20 along the person shortest route by summoning guidance robot 10b. In other words, guidance robot 10a can display information to person 20 to have guidance robot 10b guide them.

### Variation Example 4

Variation Example 4 describes a case where guidance robot 10a summons guidance robot 10b, and guidance robot 10b then guides person 20 to the guidance destination desired by person 20 along the person shortest route. However, the configuration is not limited thereto. When another guidance robot 10 provides guidance to the guidance destination instead of the one guidance robot 10, person 20 may be moved to the location where the other guidance robot 10 is present.

In other words, if guidance robot 10b is capable of taking over guidance from a location within a predetermined range from the departure point, guidance robot 10a may display an indication that guidance is possible along the person shortest route if the person moves to the location of guidance robot 10b. In this case, guidance robot 10a may further display a time required to move to the location of guidance robot 10b (a movement time). In this manner, guidance robot 10a can display information to person 20 to have guidance robot 10b guide them.

More specifically, if a comparison result indicating that the person shortest route and the robot shortest route are not the same is obtained, guidance robot 10a may further obtain robot current location information and robot travelable area information for each of one or more other guidance robots different from guidance robot 10a. Then, based on the robot current location information and the robot travelable area information for each of the one or more other guidance robots, and the guidance destination location information, guidance robot 10a may calculate another robot shortest route, which is the shortest route to the location of the guidance destination from a location within a predetermined range from the current location of guidance robot 10a. Guidance robot 10a may then specify a substitute robot that is (i) the other guidance robot 10b for which the other robot shortest route, among the other robot shortest routes, is the same as the person shortest route and (ii) is present around the location within a predetermined range. Next, guidance robot 10a may change the display format displayed on the display to a display format indicating (i) that guidance robot 10b is capable of guidance, along the person shortest route, to the location of the guidance destination from the location within a predetermined range from the current location and (ii) the location where guidance robot 10b will start the guidance.

In this case, it is sufficient for information about the other robot, such as location information of the other robot, a communication address, travelable area information, conditions of tasks of the other robot, and the like, to be stored in storage 18 of guidance robot 10a.

Note that if the specified guidance robot 10b is present near the location that is within a predetermined range from the current location of guidance robot 10a, an instruction may be given to stand by at that location. In this case, person 20 is guided to the location of the guidance destination by person 20 moving to the current location of the specified guidance robot 10b itself. Additionally, if the specified guidance robot 10b is present near the location within a predetermined range from the current location of guidance robot 10a, guidance robot 10a may summon guidance robot 10b to the location that is within the predetermined range. In this case, by summoning the specified guidance robot 10b to the location that is within a predetermined range from the current location of guidance robot 10a, and having person 20 move to the location that is within a predetermined range, person 20 is guided from the location that is within a predetermined range to the location of the guidance destination.

In this manner, when the robot shortest route and the person shortest route are different, guidance robot 10a can specify the other guidance robot 10b that is capable of guiding person 20 on the person shortest route, and display an indication that person 20 can be guided on the person shortest route if person 20 moves to the location of the specified guidance robot 10b.

Note that the walking burden on person 20 can be reduced more by guidance robot 10a summoning guidance robot 10b rather than having person 20 move to the location of guidance robot 10b, and thus the processing described in Variation Example 4 may be performed after performing the processing described in Variation Example 3.

### Modified Example 2

Modified Example 2 will describe a case where guidance robot 10 further has a mechanism for carrying luggage of person 20. Note that the processing described hereinafter can be implemented by controller 17 of guidance robot 10 executing various programs stored in storage 18.

There are cases where person 20 wishes to have luggage brought to their destination. In such a case, if person 20 is detected as carrying luggage by a sensor, guidance robot 10 may display an indication that it is possible to “move only the luggage along the robot shortest route, and have the customer move along the person shortest route”. Note that this configuration is not limited to a case where person 20 is detected as carrying luggage. If the shortest route and the robot shortest route are different, an indication that it is possible to “move only the luggage along the robot shortest route, and have the customer move along the person shortest route” may be displayed.

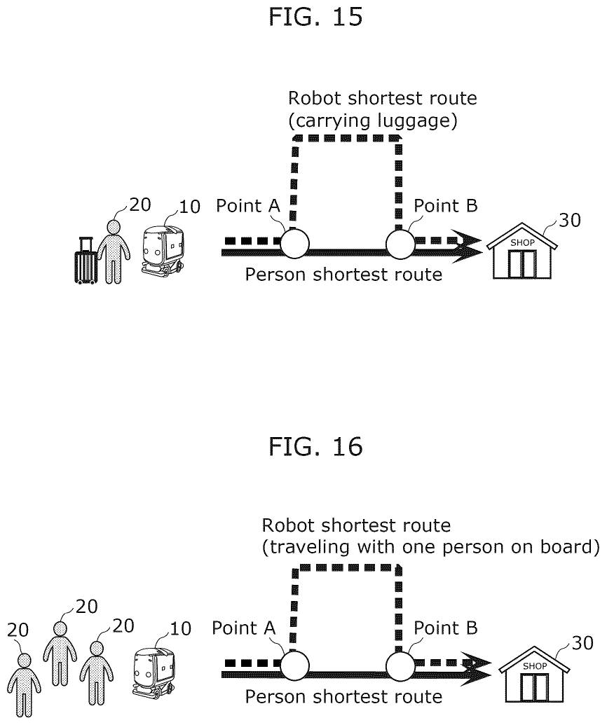

FIG. 15 is a diagram conceptually illustrating the robot shortest route and the person shortest route according to Modified Example 2 of the present embodiment. FIG. 15 illustrates a case where when the robot shortest route and the person shortest route are different, luggage is carried to shop 30 along the robot shortest route, and person 20 travels to shop 30 along the person shortest route. This enables person 20 to travel to shop 30 along the person shortest route without carrying their luggage.

More specifically, assume that guidance robot 10 is further capable of transporting luggage, and that a comparison result is obtained indicating that the person shortest route and the robot shortest route are not the same. In this case, guidance robot 10 may change the display format displayed on the display to a display format indicating that the luggage can be delivered to the guidance destination along the robot shortest route, and that person 20 can move to the guidance destination along the person shortest route.

In this manner, guidance robot 10 can present, to person 20, an indication that only the luggage of person 20 can be carried along the robot shortest route, and person 20 themselves can move along the person shortest route.

This makes it possible for person 20 to travel to the destination along the person shortest route while guidance robot 10 carries the luggage of person 20 to the destination along the robot shortest route. This in turn makes it possible to increase opportunities to use guidance robot 10 without increasing the walking burden on person 20.

Note that guidance robot 10 may carry luggage along a robot route that satisfies a predetermined condition. Here, the predetermined condition is, for example, (a) the condition that the movement distance is the shortest, (b) the condition that the luggage will vibrate or be shaken the least, (c) the condition that the movement time is the shortest, or the like.

Note that guidance robot 10 may further display a meeting location, such as the destination, and an estimated arrival time at that location, for example, such that guidance robot 10 can meet person 20 at the destination. Guidance robot 10 may further display the estimated arrival time at which person 20 is expected to arrive at the meeting location, such as the destination.

The estimated arrival time can be calculated based on (i) the normal travel speed of guidance robot 10 and the normal walking speed of person 20, and (ii) the distance from the departure point to the destination. The walking speed may be the walking speed of a typical person, and may be stored in storage 18 in advance.

Note that as in the example illustrated in FIG. 15, when the route from point B to the location of shop 30, which is the destination, overlaps between the person shortest route and the robot shortest route, the meeting location may be a location other than the destination.

Here, for example, guidance robot 10 may display a display format indicating that person 20 can select, as the meeting location, any desired location on the route between point B and the destination.

More specifically, guidance robot 10 may include a touch panel as the display, may display the robot shortest route and the person shortest route as illustrated in FIG. 15, and may enable a desired location on the robot shortest route or the person shortest route from point B to the destination to be selected by touching the touch panel. This makes it possible to set a location selected by person 20 as the meeting location.

Additionally, for example, guidance robot 10 may determine and display the meeting location.

Guidance robot 10 may set, as the meeting location, a point where the person shortest route in the robot shortest route converge again after having diverged, for example. This makes it possible to release guidance robot 10 from the guidance task earlier and move on to another task, which can improve the operational efficiency of guidance robot 10. Additionally, guidance robot 10 may set, as the meeting location, a location selected as the meeting location by person 20 in the past, for example. A location selected as the meeting location by person 20 in the past can be estimated to be a meeting location convenient for person 20, and this therefore makes it possible to improve the convenience for the user. Additionally, guidance robot 10 may set, as the meeting location, a location associated with the destination in advance, such as an area with little pedestrian traffic, an area with visible buildings, or the like. The location associated with the destination may be set by the manager of the target area, or may be set by a remote monitoring party.

Note that when the robot shortest route and the person shortest route are the same, guidance robot 10 may display an indication that “the luggage will be carried to the destination while traveling with person 20” in addition to the indication that “the luggage will be carried to the destination”. Additionally, the sensor which detects that person 20 is carrying luggage is, for example, a camera provided in guidance robot 10, and the luggage can be detected by performing image recognition on an image obtained by the camera.

### Variation Example 1

The foregoing describes a case where, when the robot shortest route and the person shortest route are different, guidance robot 10 carries the luggage to shop 30 along the robot shortest route and person 20 travels to shop 30 along the person shortest route. However, the configuration is not limited thereto. In addition to the robot travelable area information, guidance robot 10 may use extended robot travelable area information, which is not used in guidance of person 20 and which adds information about the area where guidance robot 10 is capable of traveling, to calculate the robot shortest route. The information not used in guidance of person 20 and which adds information about the area where guidance robot 10 is capable of traveling is, for example, a passage in a shopping mall or the like only used by staff members. The extended robot travelable area information may be obtained from the cloud or the like and stored in storage 18 of guidance robot 10.

Additionally, when guidance robot 10 carries the luggage to shop 30 along the robot shortest route but does not guide person 20, guidance robot 10 may be caused to travel at a higher speed than when guiding person 20. The higher speed than when guiding person 20 is a speed faster than the speed set as the normal travel speed of guidance robot 10. The higher speed may be a speed close to an upper limit speed set taking into account the performance or operations of the robot, for example, but is not limited thereto. Any speed may be set that enables the robot to arrive at the point for converging with person 20 earlier than person 20. This makes it possible for guidance robot 10 to arrive at the destination (the guidance destination) as early as possible, even when traveling along a robot shortest route having a longer distance than the person shortest route. Accordingly, not only can person 20 travel to the destination along the person shortest route without carrying their luggage, but the waiting time for receiving their luggage after arriving at the destination can also be reduced.

### Variation Example 2

There are situations where person 20 has a large amount of luggage, and the luggage therefore cannot be carried by a single guidance robot 10. In this case, the person's luggage may be carried by a plurality of guidance robots 10.

More specifically, when a single guidance robot 10 is not capable of carrying the luggage of person 20, that single guidance robot 10 may display an indication that a request to add another guidance robot 10 can be entered. Upon accepting the request from person 20, guidance robot 10 may search for another guidance robot 10 nearby that is capable of carrying luggage and, when another guidance robot 10 is discovered through the search, may summon the other guidance robot 10 to its own current robot location. Guidance robot 10 may further display a time until the other guidance robot 10 arrives at the current robot location, or may further request person 20 to determine whether to summon the other guidance robot 10.

Note that upon receiving the luggage from person 20, guidance robot 10 and the other guidance robot 10 may travel to the destination in formation. This enables guidance robot 10 and the other guidance robot 10 to arrive at the destination simultaneously, and person 20 can therefore receive the luggage at one time. Accordingly, person 20 can not only travel to the destination along the person shortest route without carrying their luggage, but can also receive their luggage at one time after arriving at the destination, which improves the convenience.

Each mechanism for carrying luggage provided in guidance robot 10 and the other guidance robot 10 may be a luggage compartment locker which can be locked and unlocked. In this case, it is preferable that the information for locking and unlocking the luggage compartment locker of guidance robot 10 and the other guidance robot 10, such as a pin number, be the same for guidance robot 10 and the other guidance robot 10, and be settable through a single setting process. This makes it possible for person 20 to hand over and receive the luggage with ease.

### Modified Example 3

Modified Example 3 will describe a case where guidance robot 10 further has a mechanism that enables a single person to board and be carried, such as a chair. Note that the processing described hereinafter can be implemented by controller 17 of guidance robot 10 executing various programs stored in storage 18.

There are situations where person 20 is not a single person, but is rather a member of a group having a plurality of people. In this case, upon detecting a group, i.e., a plurality of people 20, using a sensor, guidance robot 10 may display an indication that it is possible to “carry one person along the robot shortest route while the remaining people travel on the person shortest route”. Guidance robot 10 may display the person shortest route for the remaining people. Note that the configuration is not limited to using a sensor to detect the group, i.e., the plurality of people 20. The indication that it is possible to “carry one person along the robot shortest route while the remaining people travel on the person shortest route” may be displayed when the shortest route and the robot shortest route are different.

FIG. 16 is a diagram conceptually illustrating the robot shortest route and the person shortest route according to Modified Example 3 of the present embodiment. FIG. 16 illustrates a case where when the robot shortest route and the person shortest route are different, one person 20 is carried to shop 30 along the robot shortest route, and the remaining people 20 travel to shop 30 along the person shortest route. This makes it possible for one person 20 in the group to board guidance robot 10 and travel to shop 30.

More specifically, assume that guidance robot 10 is further capable of transporting a single person, and that a comparison result is obtained indicating that the person shortest route and the robot shortest route are not the same. In this case, guidance robot 10 may change the display format displayed on the display to a display format indicating that the one person among the plurality of people 20 can be carried to the guidance destination along the robot shortest route, and that people 20 aside from the one person can move to the guidance destination along the person shortest route.

In this manner, guidance robot 10 can present, to the plurality of people 20, an indication that only one person 20 can be carried along the robot shortest route, and the remaining people 20 can move along the person shortest route.

This makes it possible for the remaining people 20 to travel to the destination along the person shortest route while guidance robot 10 carries the one person 20 to the destination along the robot shortest route. This is because if the person shortest route and the robot shortest route are the same, the group can travel together, but if those routes are different, having the people aside from the passenger move along the person shortest route results in a lighter walking burden. This makes it possible to eliminate the walking burden for the one person 20 while avoiding increasing the walking burden on the remaining people 20, and opportunities for using guidance robot 10 can therefore be increased.

Note that the group may be a plurality of people 20 in a family of three households, for example. In this case, if person 20 is a grandfather, only person 20 may board guidance robot 10 and travel to the destination. The group may be a plurality of people 20 acting together, and may be a plurality of people 20 for which the destination is the same in the group.

Additionally, when displaying the indication that it is possible to “carry one person along the robot shortest route while the remaining people travel on the person shortest route”, guidance robot 10 may further display the person shortest route, or both the robot shortest route and the person shortest route, to the remaining people. This makes it possible for the remaining people 20 to determine whether to use guidance robot 10, or whether it is possible to travel with guidance robot 10.

The sensor for detecting that people 20 are a group of a plurality of people is, for example, a camera provided in guidance robot 10. Guidance robot 10 can detect that people 20 are a group of a plurality of people by performing image recognition on an image obtained by the camera. The image recognition on the image obtained by the camera may be triggered by one person in the group touching the display of guidance robot 10.

People 20 can be detected as being a group of a plurality of people when image recognition is performed and it is determined that person 20 is in contact with another person 20 in the vicinity, such as by holding hands, carrying a child, or the like. People 20 can also be detected as being a group of a plurality of people when guidance robot 10 performs image recognition and determines that, for example, a distance between person 20 and another person 20 in the vicinity is shorter than a predetermined distance and that that state has continued for at least a predetermined period. Making such a determination enables guidance robot 10 to avoid taking a person who is simply nearby person 20, such as a person who has passed by person 20, as a member of the group. Note that guidance robot 10 may detect people 20 as being a group of a plurality of people by having people 20 enter information indicating that they are a group of a plurality of people, rather than performing image recognition.

### Modified Example 4

Modified Example 4 will describe a case where when guidance robot 10 guides person 20 to partway along the person shortest route, after this guidance, guidance robot 10 performs processing for monitoring the subsequent movement of person 20 along the person shortest route. Note that the monitoring processing described hereinafter can be implemented by controller 17 of guidance robot 10 executing various programs stored in storage 18.

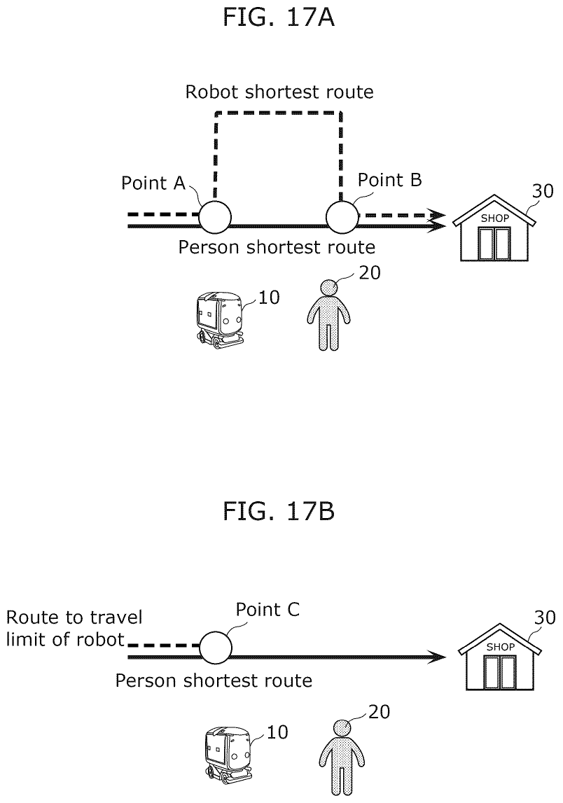

FIGS. 17A and 17B are diagrams conceptually illustrating the monitoring processing by guidance robot 10 according to Modified Example 4 of the present embodiment. FIG. 17A illustrates an example of a case where guidance robot 10 guides person 20 to point A, which is a travel limit point where the person shortest route and the robot shortest route diverge, and then transitions to a monitoring mode. After point A, guidance robot 10 monitors person 20 as they move along the person shortest route, until they pass point C and arrive at shop 30, which is the destination. FIG. 17B illustrates an example in which guidance robot 10 guides person 20 to point C, which is the travel limit point, and then transitions to the monitoring mode. After point C, guidance robot 10 monitors person 20 as they move along the person shortest route, until they arrive at shop 30, which is the destination. Person 20 is a child or a woman, for example, and the safety can be improved for the child when walking alone, the woman when traveling at night, and the like by having guidance robot 10 perform the monitoring processing.

More specifically, assume that guidance robot 10 guides person 20 to a midpoint of the person shortest route, which is the travel limit point, and then transitions to the monitoring mode. In this case, based on the calculated person shortest route, guidance robot 10 may specify the direction in which person 20 travels from the midpoint to the destination, and then use a sensor such as a camera to determine whether person 20 is moving in the specified direction while tracking the movement of person 20.

If guidance robot 10 determines that person 20 is moving in the specified direction, the movement of person 20 may be tracked until a predetermined monitoring end condition is satisfied. When the predetermined monitoring end condition is satisfied, guidance robot 10 notifies a terminal of a monitoring party for person 20, registered in advance, that person 20 has arrived at the destination. Here, in addition to the arrival, evidence such as an image of the moment when person 20 arrives at the destination, time information, or the like may be included in the notification. On the other hand, if person 20 is determined not to be moving in the specified direction, guidance robot 10 may notify person 20 of the direction in which person 20 should travel, using a display, audio, or the like.

The monitoring end condition is, for example, that person 20 has arrived at the destination. By performing image recognition on an image obtained from a sensor such as a camera, guidance robot 10 can recognize the destination and identify that person 20 has arrived at the destination. In addition, further using a sensor such as a range sensor to determine whether the distance from guidance robot 10 to person 20 and the distance from guidance robot 10 to the destination are substantially the same makes it possible to determine that person 20 has arrived at the destination and the monitoring end condition is therefore satisfied. Note that the monitoring end condition is not limited to person 20 arriving at the destination, for example, and may be person 20 arriving at a location that can be monitored, a predetermined length of time passing, or person 20 having moved a predetermined distance. For example, if a right/left turning point is present along the person shortest route guided by guidance robot 10 from the midpoint to the destination, the location it can be monitored is the right/left turning point or the like. This is because guidance robot 10 is only capable of tracking person 20 until before the right/left turning point, and cannot continue the monitoring processing thereafter.

Additionally, although the foregoing described a configuration where if person 20 is determined not to be moving in the specified direction, guidance robot 10 makes a notification of the direction in which person 20 should travel, using a display, audio, or the like, the configuration is not limited thereto. If person 20 is determined not to be moving in the specified direction, guidance robot 10 may display guidance for the subsequent person shortest route, toward the direction in which person 20 should travel. The display of guidance is not limited to displaying text such as “turn right at the second traffic light”, and a map indicating the subsequent person shortest route may be displayed instead. This makes it possible for person 20 to confirm that guidance display by looking back while moving, which may make it possible to travel along the subsequent person shortest route without becoming lost.

If person 20 is a child, the monitoring party using the monitoring party terminal is, for example, a guardian, a manager at a facility such as a lost child center, or the like. If person 20 is a woman, the monitoring party may be the police, for example.

A configuration has been described where when the predetermined monitoring end condition is satisfied, guidance robot 10 notifies a terminal of a monitoring party for person 20, registered in advance, that person 20 has arrived at the destination or a location that can be monitored. However, the configuration is not limited thereto. If person 20 is determined not to be moving in the specified direction, guidance robot 10 may further notify the monitoring party terminal that person 20 has moved in a direction different from the direction of the destination.

Additionally, when performing the monitoring processing, guidance robot 10 may authenticate person 20 to be guided, determine whether person 20 is to be monitored, and perform the monitoring processing only when person 20 is to be monitored.

### Modified Example 5

The foregoing Embodiment 1, Modified Example 1, and the like described a configuration where guidance robot 10 calculates not only its own robot shortest route but also the person shortest route of a person aside from itself, and according to a result of comparing the routes, displays guidance in a display format that causes person 20 to recognize whether guidance along the person shortest route is possible. However, the configuration is not limited thereto. Instead of displaying guidance, the display of an advertisement may be controlled in accordance with the comparison result. More specifically, guidance robot 10 may compare the calculated person shortest route and robot shortest route, and control the display of a specified advertisement in accordance with a comparison result obtained from the comparison. Through this, when viewing an advertisement displayed by guidance robot 10, person 20 can recognize whether they can be guided to shop 30 that is the subject of the advertisement along a robot shortest route that is the same as the person shortest route.

Note that guidance robot 10 may display an advertisement of the shop to which guidance is possible from the current location along the person shortest route. Specifically, guidance robot 10 may hold location information of each of shops, determine whether guidance is possible to each of the shops from the current location along the person shortest route, and display an advertisement for a shop to which guidance is possible from the current location along the person shortest route. Additionally, guidance robot 10 may display an advertisement for at least one shop present on the person shortest route from the current location. This makes it possible for guidance robot 10 to issue advertisements to an unspecified number of people, and thus person 20 who views the advertisement can request guidance from guidance robot 10 displaying the advertisement.

Additionally, guidance robot 10 may display an advertisement for a shop to which guidance is possible from the current location along the person shortest route with priority over an advertisement for a shop to which guidance is possible along a route that is not the person shortest route. Guidance robot 10 can display the advertisement for the shop to which guidance is possible along the person shortest route with priority by, for example, increasing the display size, extending the advertisement time, increasing the advertisement frequency, changing the display format, or the like. Additionally, guidance robot 10 may change the display format by superimposing an indication that “guidance is possible along the person shortest route” on the advertisement for the shop to which guidance is possible along the person shortest route, such that the priority display is performed in an identifiable manner, or may vary the background color of the advertisement for the shop to which guidance is possible along the person shortest route.

In addition to an advertisement for a shop to which guidance is possible along the route that is not the person shortest route, guidance robot 10 may display a difference from the distance of the person shortest route. Guidance robot 10 may vary the control of the display of the advertisement, such as by changing the display size, the advertising time, the advertisement frequency, the display format, or the like, in accordance with the difference from the distance of the person shortest route.

Such advertisement display control can be implemented by controller 17 of guidance robot 10 executing various programs stored in storage 18. The advertisement for the guidance destination may be made by obtaining advertisement information stored in the cloud or the like, and the obtained advertisement information may be stored in storage 18.

Note that guidance robot 10 may control the display of advertisements along with displaying the guidance as described in Embodiment 1, Modified Example 1, and the like. More specifically, in addition to displaying guidance in a display format that causes person 20 to recognize whether guidance is possible along the person shortest route in accordance with a comparison result, guidance robot 10 may also control the display of an advertisement specified in accordance with the comparison result. For example, if a comparison result indicating that the person shortest route and the robot shortest route are not the same is obtained, guidance robot 10 may further change the display format displayed on the display to a display format that displays an advertisement for a shop present on the person shortest route. The processing through which guidance robot 10 obtains the robot current location information, the guidance destination location information, the person movable area information, and the robot travelable area information has already been described in Embodiment 1, and will therefore not be described here.

When, for example, a comparison result indicating that the person shortest route and the robot shortest route are not the same is obtained, guidance robot 10 may display only an advertisement pertaining to a shop present on the person shortest route, or may highlight only an advertisement pertaining to a shop present on the person shortest route, such as by changing the color thereof. Note, however, that the display method used by guidance robot 10 when the comparison result is obtained is not limited to the foregoing examples.

For example, guidance robot 10 may display only an advertisement for a shop present on a route in which the person shortest route and the robot shortest route overlap. Guidance robot 10 may also display an advertisement for a shop present on the stated overlapping route with priority over an advertisement for a shop present on a route in which the person shortest route and the robot shortest route do not overlap, by increasing the size of the display on the screen, prolonging the display time, increasing the display frequency, or the like.

Additionally, when the comparison result is obtained, guidance robot 10 may display an advertisement for a shop present on the stated overlapping route and an advertisement for a shop present on a non-overlapping route so as to be distinguishable from each other. Guidance robot 10 can provide this distinguishable display by, for example, superimposing information indicating “guidance possible along person shortest route”, “guidance possible along route that is not person shortest route”, or the like on the advertisements for the shops, varying the background colors of the advertisements for the shops, or the like.

Additionally, when the comparison result is obtained, guidance robot 10 may further vary the display format according to the difference between the distances of the person shortest route and the robot shortest route. For example, when the difference between the distances is greater than a predetermined value, guidance robot 10 may skip displaying an advertisement, or may display an advertisement with priority as described above as the difference between the distances decreases. This is because if the difference between the distances is small, guidance may be provided along the robot shortest route, but if the difference between the distances is greater than the predetermined value, guidance along the robot shortest route is inappropriate and it is less burdensome for person 20 to travel along the person shortest route.

### Variation Example 1

As described in Modified Example 1, when, for example, guidance such as shop 30 on the second floor is displayed by guidance robot 10 that is only capable of guidance on the first floor, guidance robot 10 can only travel as far as an elevator entrance, but cannot move to the second floor. In other words, there are cases where guidance robot 10 has a travel limit. This case will be described as Variation Example 1.

Based on the robot current location information, the guidance destination location information, and the robot travelable area information, guidance robot 10 may determine whether guidance robot 10 is capable of traveling to the location of the guidance destination, and control the display of advertisements in accordance with a result of determining whether it is possible to guide person 20 to the shop that is the destination (the guidance destination).

For example, guidance robot 10 may display, in a superimposed manner, an indication as to whether guidance to the destination of person 20 is possible, in accordance with the determination result. Additionally, guidance robot 10 may display the superimposed indication that guidance is possible with priority over the superimposed indication that guidance is not possible, by increasing the display frequency, enlarging the display region, or the like. When enlarging the display region, the advertisement of the shop may be displayed on the entire screen, for example, whereas when not enlarging the display region, a plurality of advertisements for shops may be displayed on one screen.

Additionally, for example, guidance robot 10 may, in accordance with the determination result, vary the display format according to whether the advertisement is for a shop present on a route to a travel limit point or for a shop present on a route which is beyond the travel limit point and on which guidance cannot be provided. When varying the display format, guidance robot 10 may vary the background, the background color, or the details of a message displayed superimposed on the advertisement, according to whether the advertisement is for a shop present on a route to a travel limit point or for a shop present on a route on which guidance cannot be provided. The details of the message displayed in a superimposed manner are, as described above, that guidance is possible, that guidance is not possible, that guidance is possible up to midway (the travel limit point), or the like.

Note that if, for example, guidance robot 10 is not capable of guiding person 20 to the destination, the display format may be varied according to whether the advertisement is for a shop which is present on a route to a travel limit point and for which guidance is therefore possible up to midway, or for a shop which is present on a route which is after the travel limit point and for which guidance is therefore not possible.

Additionally, guidance robot 10 may display an indication that guidance is possible up to the travel limit point, superimposed on an advertisement for a shop or the like, and may display an indication that guidance is not possible from the travel limit point to the destination, superimposed on an advertisement for a shop or the like.

As described in Variation Example 1 of Modified Example 1, there are cases where guidance robot 10 is only capable of guidance to the travel limit point, but another guidance robot 10 is capable of guidance from the travel limit point to the guidance destination. In other words, guidance robot 10 according to Modified Example 1 may have another guidance robot 10 take over guidance along a route from the travel limit point to the guidance destination, which the one guidance robot 10 cannot provide.

In this case, guidance robot 10 may search for and specify another guidance robot 10 capable of the guidance, make a guidance request including a takeover location to the other guidance robot 10, and, when the request is accepted, display an indication that the other guidance robot 10 will take over the guidance in a superimposed manner that is recognizable.

More specifically, assume that guidance robot 10 has obtained a comparison result indicating (i) that guidance robot 10 itself is not capable of travel to the location of the guidance destination and (ii) a boundary point, in the person shortest route, where overlap between the robot shortest route and the person shortest route ends. In this case, guidance robot 10 may obtain the robot current location information and the robot travelable area information for each of other guidance robots 10 and, for each of the other guidance robots 10, calculate another robot shortest route from the boundary point to the location of the guidance destination. Next, guidance robot 10 may specify another guidance robot 10 having another robot shortest route that, among the other robot shortest routes, overlaps with the person shortest route from the boundary point to the location of the guidance destination. Guidance robot 10 may then make a guidance request, including the boundary point (a takeover point), to the specified other guidance robot 10, and when the request is approved, may display an indication that the other guidance robot 10 will take over the guidance in a superimposed manner that is recognizable. Note that when displaying the indication that the other guidance robot 10 will take over the guidance in a superimposed manner that is recognizable, guidance robot 10 may further display an inquiry asking person 20 whether it is necessary for the other guidance robot 10 to take over the guidance.

### Variation Example 2

When a shop serving as a guidance destination (destination) for person 20 is within a predetermined range, such as a range visible from the current robot location, guidance robot 10 may use a different display format and display method than those used for shops outside of the predetermined range, such as a range visible from the current robot location. For example, for a shop that is a guidance destination within a range visible from the current robot location, guidance robot 10 may display an advertisement for the shop, and display the location of the shop in a recognizable manner. This enables person 20 to visually understand the location of the shop even without being guided thereto. Accordingly, guidance robot 10 can guide person 20 to the destination while also advertising the shop to person 20, which makes it possible to reduce the amount of time guidance robot 10 spends on the service for guiding person 20. Note that the predetermined range displayed, such as the visible range, can be determined according to whether the range appears in an image obtained from a sensor, such as a camera, provided in guidance robot 10.

### Embodiment 2

Embodiment 1 described a case where guidance robot 10 is provided in a shopping mall to be capable of guiding person 20 to a desired shop, and person 20 moves to the front of guidance robot 10 to receive the guidance, as an example. However, the configuration is not limited thereto. A reception robot may be present at a predetermined location, and person 20 may receive guidance by moving in front of the reception robot and having guidance robot 10 dispatched thereto.

### 2 Guidance System

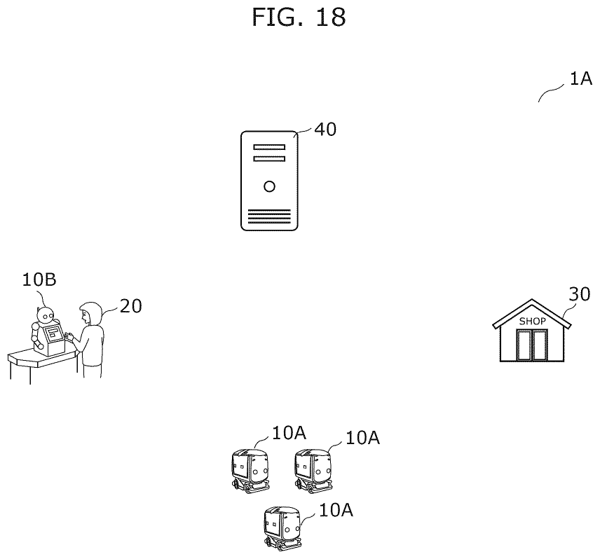

FIG. 18 is a diagram illustrating an example of guidance system 1A including guidance robot 10A according to the present embodiment. Elements identical to those described in Embodiment 1, such as in FIG. 1, are given the same reference signs and will not be described in detail.

Guidance system 1A illustrated in FIG. 18 is constituted by a plurality of guidance robots 10A, reception robot 10B, and cloud 40.

Like guidance robot 10 according to Embodiment 1, guidance robot 10A is a robot capable of autonomous movement for guiding a person to a guidance destination. Guidance robot 10A, too, may be remotely monitored and remotely controlled by a remote monitoring party over a network (not shown) when necessary.

Reception robot 10B is a robot, positioned at a predetermined location, for dispatching guidance robot 10A to guide person 20 to shop 30, which is a destination, for example.

Cloud 40 is constituted by one or more servers, for example, and is communicably connected to guidance robot 10A and reception robot 10B over a network (not shown).

The following will describe, as an example, a case where person 20 is a customer of a shopping mall, reception robot 10B accepts a desired shop (destination) from person 20 and dispatches guidance robot 10A capable of guidance to the desired shop, and guidance robot 10A then guides person 20 to the desired shop.

### 2.1 Cloud 40

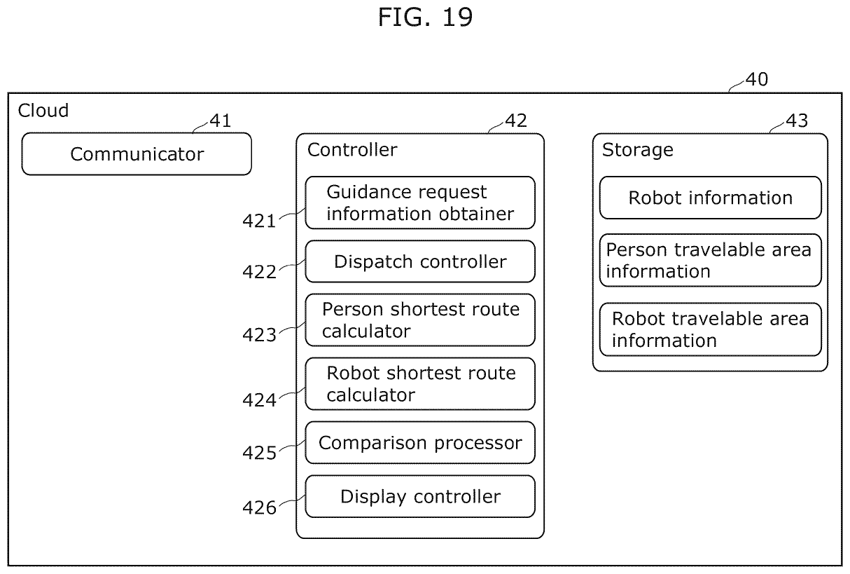

FIG. 19 is a block diagram illustrating an example of the functional configuration of cloud 40 according to the present embodiment.

As illustrated in FIG. 19, cloud 40 includes communicator 41, controller 42, and storage 43.

Communicator 41 is a communication interface, for example, and can connect to a network. Communicator 41 is communicably connected to reception robot 10B and each of the plurality of guidance robots 10A over the network.

In the present embodiment, communicator 41 obtains guidance request information from reception robot 10B, including information on the destination of person 20, the location of reception robot 10B, and a guidance start location, sends an instruction to move at least one guidance robot 10A determined based on the guidance request information to the guidance start location included in the guidance request information, and the like.

Controller 42 performs control for determining at least one guidance robot 10A based on the guidance request information obtained, generating an instruction to dispatch the at least one guidance robot 10A determined to guide person 20, determining information to be displayed by the at least one guidance robot 10A determined, and the like. Controller 42 is implemented, for example, by a computer that includes at least a processor, and implements various functions by the processor executing programs stored in a memory or storage 43.

As illustrated in FIG. 19, in the present embodiment, controller 42 includes guidance request information obtainer 421, dispatch controller 422, person shortest route calculator 423, robot shortest route calculator 424, and comparison processor 425. Note that person shortest route calculator 423, robot shortest route calculator 424, and comparison processor 425 have the same functional configurations as person shortest route calculator 173, robot shortest route calculator 174, and comparison processor 175 according to Embodiment 1, and will therefore not be described here.

Guidance request information obtainer 421 obtains guidance request information including information on the destination of person 20 accepted by reception robot 10B, the location of reception robot 10B, and the guidance start location. In the present embodiment, like obtainer 171 according to Embodiment 1, guidance request information obtainer 421 further obtains information about the guidance destination, the guidance destination location information indicating the location of the guidance destination, and the robot current location information indicating the current location of each of the plurality of guidance robots 10A. In addition, guidance request information obtainer 421 obtainst the person movable area information, as well as the robot travelable area information of each of the plurality of guidance robots 10A. The information about the guidance destination, the guidance destination location information, the robot current location information, the person movable area information, and the robot travelable area information are the same as in Embodiment 1, and will therefore not be described here.

Dispatch controller 422 determines at least one guidance robot 10A based on the guidance request obtained, generates an instruction to dispatch the at least one guidance robot 10A determined to guide person 20, and the like.

In the present embodiment, dispatch controller 422 determines guidance robot 10A for which both the person shortest route and the robot shortest route are the same. Dispatch controller 422 generates an instruction to dispatch guidance robot 10A determined to the guidance start location. Note that if person 20 cannot be guided along the person shortest route by a single guidance robot 10A but can be guided along the person shortest route by a plurality of guidance robots 10A, dispatch controller 422 determines a plurality of guidance robots 10A. In this case, dispatch controller 422 may generate an instruction to dispatch the plurality of guidance robots 10A to the guidance start location, a takeover guidance start location, or the like.

Storage 43 is a database storing various types of information, and is implemented by an HDD, an SSD, or the like. In the present embodiment, storage 43 stores the person movable area information and the robot travelable area information. Storage 43 also stores shop information obtained by communicator 41, robot information, which is information about the plurality of guidance robots 10A, and programs for controller 42 and the like to perform processing. The shop information is the same as that described in Embodiment 1, and will therefore not be described here. The robot information includes a robot travelable area information identification number, which is associated with identification information (robot identification information), location information (a current robot location), service status information, and robot travelable area information for each of the plurality of guidance robots 10A. The service status information is information indicating, for example, whether the corresponding guidance robot 10A is currently providing guidance.

### 2.2 Reception Robot 10B

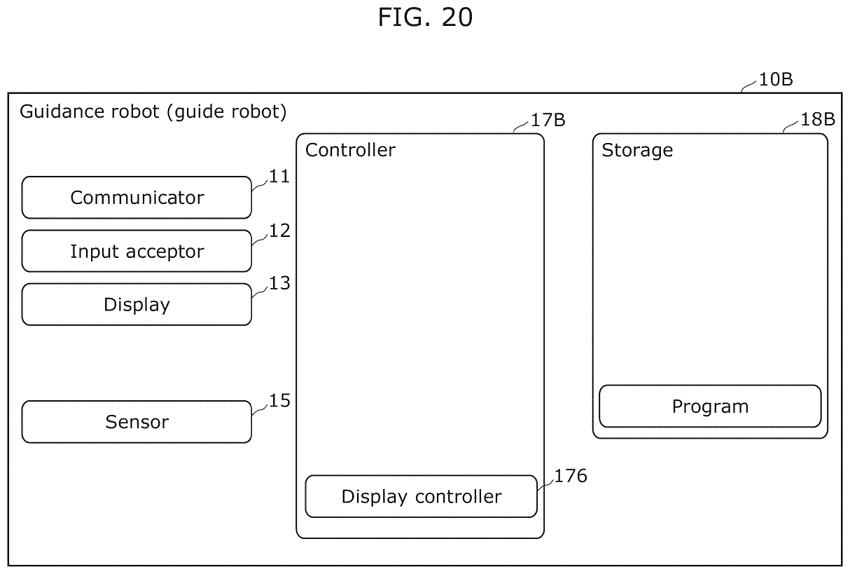

FIG. 20 is a block diagram illustrating an example of the functional configuration of reception robot 10B according to the present embodiment.

As illustrated in FIG. 20, reception robot 10B includes communicator 11B, input acceptor 12B, display 13B, sensor 15B, controller 17B, and storage 18B.

Communicator 11B is a communication interface, for example, and can connect to a network. Communicator 11B is communicably connected to an external device such as cloud 40 over a network. In the present embodiment, communicator 11B sends information on the destination of person 20, input by person 20 through input acceptor 12B, and the guidance start location, including the location of reception robot 10B, to cloud 40, receives information on the at least one guidance robot 10A determined based on the guidance request information, and the like.

Input acceptor 12B accepts inputs from person 20. Input acceptor 12B is a user interface such as an input button, a touchpad, a touchscreen, or the like. Note that in addition to accepting tactile operations from person 20, input acceptor 12B may also be configured to accept voice operations and remote operations using a remote controller or the like, and may be integrated with display 13B. In the present embodiment, input acceptor 12B accepts inputs such as information on the destination of person 20, the guidance start location, and the like. Note that if the guidance start location is the location of reception robot 10B, inputting the guidance start location can be skipped. Alternatively, input acceptor 12B may start accepting inputs when an indication that person 20 is present near reception robot 10B is obtained by sensor 15B.

Display 13B outputs information to person 20. Display 13B may be, for example, an LCD monitor, or may be combined with input device 106 to implement a touchscreen. In the present embodiment, display 13B displays guidance. Note that display 13B can display the guidance in the various display formats described in Embodiment 1. Alternatively, display 13B may display an indication that guidance robot 10A has been dispatched to provide guidance to shop 30, which is the destination, and may further display the guidance start location and, if takeover guidance is to be provided, the takeover guidance start location.

Sensor 15B obtains sensing information from a sensor that senses the conditions around reception robot 10B and the like.

Controller 17B performs control to cause person 20 to recognize whether guidance is possible along the person shortest route, by controlling the guidance in display 13B and the display format in which the guidance is displayed. Controller 17B is implemented, for example, by a computer that includes at least a processor, and implements various functions by the processor executing programs stored in a memory or storage 18B.

In the present embodiment, controller 17B includes display controller 176, as illustrated in FIG. 20.

Display controller 176 displays guidance obtained from cloud 40 in accordance with a comparison result. Display controller 176 displays the guidance in a display format instructed by cloud 40.

Storage 18B is a database storing various types of information, and is implemented by an HDD, an SSD, or the like.

In the present embodiment, storage 18B stores programs for the processing performed by controller 17B and communicator 11 to sensor 15B.

### 2.3 Guidance Robot 10A

Like guidance robot 10 according to Embodiment 1, guidance robot 10A is an autonomously-mobile robot for guiding person 20 to a guidance destination, and is capable of at least one of remote operation or remote monitoring by a remote monitoring party. Guidance robot 10A includes a display, and causes person 20 to recognize whether guidance along a person shortest route is possible by a display format of guidance displayed on the display. Note that as long as guidance robot 10A is capable of guiding person 20, guidance robot 10 may have a mechanism enabling luggage of person 20 to be carried, or a mechanism capable of moving one person, such as person 20, on board.

Guidance robot 10A is implemented by a computer configured having a hardware configuration such as that illustrated in FIG. 2, for example, and is capable of guiding person 20 to a guidance destination desired by person 20.

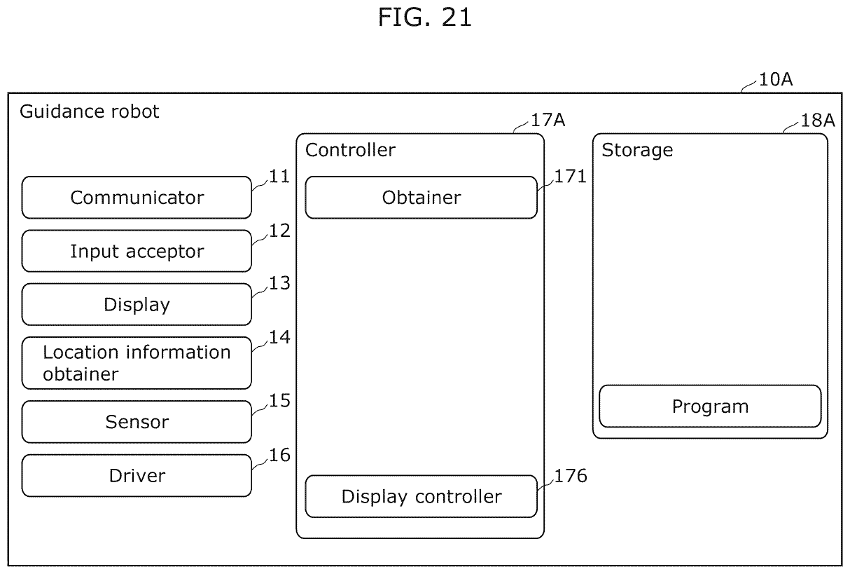

FIG. 21 is a block diagram illustrating an example of the functional configuration of guidance robot 10A according to the present embodiment.

As illustrated in FIG. 21, guidance robot 10A includes communicator 11, input acceptor 12, display 13, location information obtainer 14, sensor 15, and driver 16 as basic functional configurations, and further includes controller 17A and storage 18A. Elements identical to those described in Embodiment 1 and illustrated in FIG. 3 are given the same reference signs and will not be described in detail.

Guidance robot 10A illustrated in FIG. 21 differs from guidance robot 10 illustrated in FIG. 3 in terms of the configurations of controller 17A and storage 18A. More specifically, controller 17A includes obtainer 171 and display controller 176, while shop guidance information generator 172, person shortest route calculator 173, robot shortest route calculator 174, and comparison processor 175, which were provided in controller 17 in FIG. 3, are configured in cloud 40 instead. As such, by obtaining a result processed in cloud 40, guidance robot 10A can cause person 20 to recognize whether guidance along the person shortest route is possible according to the display format of the guidance displayed on the display as described in Embodiment 1.

### 2.4 Examples of Operations in Cloud 40

Examples of operations performed in cloud 40 will be described hereinafter. Note that the following descriptions will focus on the characteristic processing in the present embodiments, and thus the same processing as that described in Embodiment 1 may be omitted from the descriptions.

### Operation Example 1

Cloud 40 calculates a person shortest route, which is the shortest route for person 20 from the guidance start location to the location of the guidance destination, based on the guidance start location, the guidance destination location information, and the person movable area information obtained. Cloud 40 also calculates, for each guidance robot 10A, a robot shortest route, which is the shortest route from the current location of guidance robot 10A to the location of the guidance destination, based on the guidance start location, the guidance destination location information, and the robot travelable area information for each guidance robot 10A.

Cloud 40 then compares the person shortest route with the robot shortest route for each guidance robot 10A, and determines guidance robot 10A for which the robot shortest route is the same as the person shortest route.

Cloud 40 then generates an instruction to dispatch guidance robot 10A determined to the guidance start location, and sends the instruction to guidance robot 10A determined. Through this, cloud 40 can dispatch guidance robot 10A determined to the guidance start location. Accordingly, guidance robot 10A can arrive at the guidance start location, and can therefore start guiding person 20 to the guidance destination.

Note that if, when the person shortest route is compared with the robot shortest route for each guidance robot 10A, there are a plurality of guidance robots 10A for which the robot shortest route is the same as the person shortest route, cloud 40 may select and determine guidance robot 10A having the smallest travelable area among the plurality of guidance robots 10A. This is because leaving guidance robot 10A having a larger travelable area increases the likelihood that, if cloud 40 obtains guidance request information for another person 20 thereafter, guidance robot 10A for which the robot shortest route is the same as the person shortest route for the other person 20 can be selected.

Additionally, if, when the person shortest route is compared with the robot shortest route for each guidance robot 10A, there are a plurality of guidance robots 10A for which the robot shortest route is the same as the person shortest route, cloud 40 may select and determine guidance robot 10A that is closest to the guidance start location among the plurality of guidance robots 10A.

### Operation Example 2

If cloud 40 compares the person shortest route with the robot shortest route for each guidance robot 10A, but there is no robot shortest route that is the same as the person shortest route, there are situations where person 20 can be guided along the person shortest route by using a plurality of guidance robots 10A. In this case, cloud 40 may dispatch a plurality of guidance robots 10A to the guidance start location and a takeover guidance start location.

More specifically, if no guidance robot 10A for which the robot shortest route is the same as the person shortest route is present, cloud 40 may first determine guidance robot 10A having a robot shortest route (i) along which guidance from the guidance start location is possible and (ii) which overlaps with the person shortest route. Cloud 40 may then determine a plurality of other guidance robots 10A capable of guidance to the guidance destination (the destination), such as by specifying other guidance robots 10A having robot shortest routes (i) along which guidance is possible from a point of divergence from the person shortest route and (ii) which overlap with the person shortest route.

This makes it possible to guide person 20 from the guidance start location to the destination.

Note that when takeover guidance is performed, cloud 40 may obtain a guidance terminable location and a takeover guidance initiable location from storage 43. In this case, cloud 40 may determine guidance robot 10A which is capable of (i) guidance from the guidance start location and (ii) along the person shortest route to the takeover guidance initiable location. Next, cloud 40 may determine a plurality of other guidance robots 10A capable of guidance from the takeover guidance initiable location to the guidance destination (the destination), based on, for example, guidance robot 10A which is capable of (i) guidance from the guidance initiable location and (ii) along the person shortest route to the next takeover guidance initiable location.

This makes it possible to guide person 20 from the guidance start location to the destination.

Note that the guidance terminable location and the takeover guidance initiable location may be set in advance, or may be set by a remote monitoring party. Additionally, the guidance terminable location and the takeover guidance initiable location need not be the same location, and may be different locations. Through this, for example, the first guidance robot 10A can provide guidance from the guidance start location to an escalator entrance or an elevator entrance, and then the next guidance robot 10A can provide guidance from the escalator exit or the elevator exit to the destination.

Additionally, the guidance terminable location and the takeover guidance initiable location are not limited to being within a predetermined distance. If the route from the guidance terminable location to the takeover guidance initiable location does not diverge and the route is therefore visible, the means for the person to move from the guidance terminable location to the takeover guidance initiable location may be any predetermined means, such as the entrance or exit to or from an escalator or an elevator.

### 2.5 Other Applications

Although in the present embodiment, guidance system 1A is applied to a case where person 20 is guided to a desired shop in a shopping mall, the configuration is not limited thereto. The system can also be applied to a case where person 20 is guided to a desired location in, for example, a city hall (called a “first case” hereinafter).

In the first case, person 20 inputs their purpose for visiting the city hall (e.g., obtaining a resident card) using reception robot 10B, which is provided at a reception area in the city hall. Reception robot 10B determines a destination (e.g., a residential affairs department on the second floor) and a guidance destination (e.g., in front of an elevator on the first floor) corresponding to the input purpose of the visit by referring to correspondence information indicating a correspondence relationship between the purpose of the visit to the city hall, the destination, and the guidance destination. Through this, reception robot 10B dispatches guidance robot 10A that is capable of guiding person 20 to the guidance destination determined.

Alternatively, guidance system 1A can also be applied to a case where, for example, person 20 is guided to a desired location in a hospital (called a “second case” hereinafter).

In the second case, person 20 inputs the purpose of their visit (e.g., taking an x-ray) using reception robot 10B, which is provided at a reception area in the hospital. Reception robot 10B determines a guidance destination corresponding to the purpose of the visit that has been input (e.g., in front of an examination room) by referring to correspondence information indicating a correspondence relationship between the purpose of the visit and the guidance destination. Through this, reception robot 10B dispatches guidance robot 10A that is capable of guiding person 20 to the guidance destination determined.

After guiding person 20 to in front of the examination room, for example, guidance robot 10A moves to a different location rather than waiting in front of the examination room. For example, if person 20 needs to move to the doctor's office after the examination, guidance robot 10A which initially provided the guidance determines another guidance robot 10A capable of guiding person 20 from in front of the examination room to in front of the doctor's office. At this time, it is preferable for the other guidance robot 10A to carry over the information about the next guidance destination from guidance robot 10A which initially provided the guidance. As a result, the other guidance robot 10A moves to in front of the examination room when the examination ends, and then guides person 20 from in front of the examination room to in front of the doctor's office. This enables person 20 to move smoothly within the hospital without getting lost.

Note that the other guidance robot 10A may determine the timing at which the examination will end by estimating the time required for the examination based on the past examination history. Alternatively, the other guidance robot 10A may determine the timing at which the examination will end by having a device, an operator, or the like in the examination room send a notification that the examination is complete to the other guidance robot 10A. Additionally, if the entrance and exit of the examination room are different, the other guidance robot 10A may be moved to the exit of the examination room. Guidance robot 10A providing guidance from in front of the examination room to in front of the doctor's office may be the same as guidance robot 10A that initially provided the guidance.

### Embodiment 3

Embodiment 1 and Embodiment 2 mainly describe cases where person 20 is a customer of a shopping mall, for example, and guidance robot 10 or the like is capable of guiding person 20 to a desired shop. However, the configuration is not limited thereto. If person 20 is a guest attending an event such as a concert, for example, guidance robot 10 or the like may be provided near a station or the venue in advance, according to a time period. In other words, a case where guidance robot 10 guides person 20, who is a guest, from the vicinity of a station to a facility or the like in the venue where the event is being held, or guides person 20 from the facility or the like in the venue where the event is held to the vicinity of the station. Details described in Embodiment 1 and Embodiment 2 will be omitted from the following descriptions.

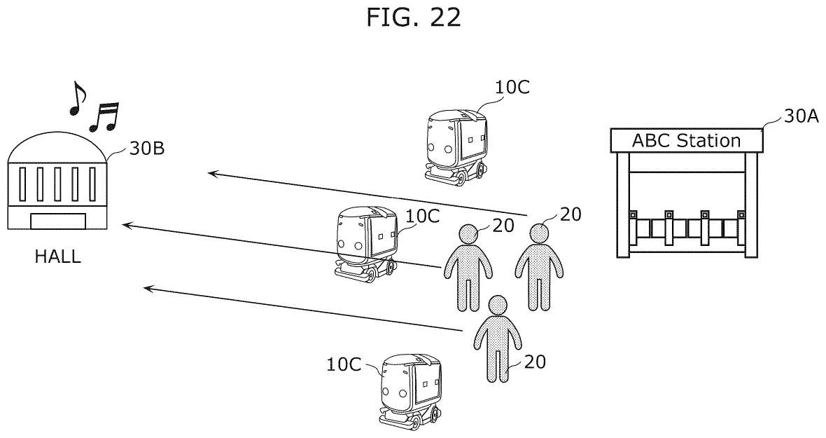

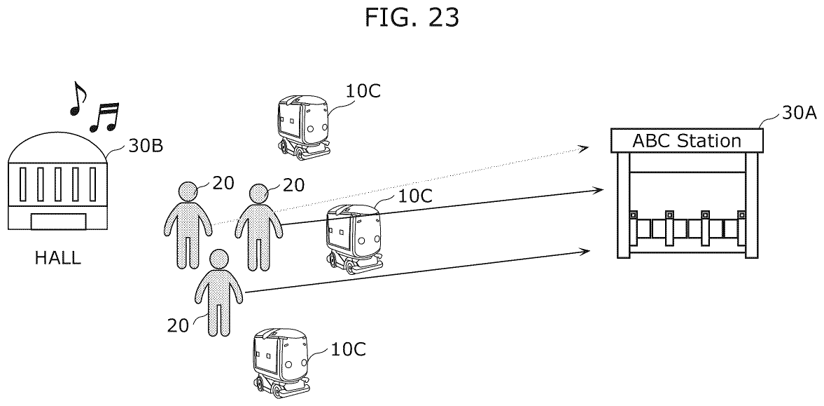

FIG. 22 is a diagram conceptually illustrating the arrangement of guidance robots 10C in a time period before an event, according to the present embodiment. FIG. 23 is a diagram conceptually illustrating the arrangement of guidance robots 10C in a time period after the event, according to the present embodiment. Guidance robot 10C has a functional configuration that combines the functional configurations of guidance robot 10A and reception robot 10B according to Embodiment 2. In other words, the descriptions here assume that most of the processing by guidance robot 10A described in Embodiment 1 is performed in cloud 40 illustrated in FIG. 19 for guidance robot 10C.

In the case of an event such as a concert, the requested guidance destination will depend to some extent on the time period. For example, as illustrated in FIG. 22, in the time period before the event, such as before a concert, many people 20 are traveling from station 30A to the event venue, and it can therefore be expected that facility 30B, such as the concert venue, will often by the guidance destination. On the other hand, as illustrated in FIG. 23, in the time period after the event, such as after the concert, many people 20 are traveling from facility 30B, such as the concert venue, to station 30A, and it can therefore be expected that station 30A will often be the guidance destination. Accordingly, guidance robot 10C, which is capable of guidance to the guidance destination along the person shortest route, may be provided near the station or the venue in advance, depending on the time period. This makes it possible to improve the convenience for person 20 using guidance robot 10C.

An example of operations performed in cloud 40 will be described hereinafter. Note that the following descriptions will focus on the characteristic processing in the present embodiments, and thus the same processing as that described in Embodiment 2 and the like will be omitted from the descriptions.

### Example of Operations

In this example of operations, the robot information stored in storage 43 further includes history information about guidance performed by each of the plurality of guidance robots 10C. The history information includes at least a robot identification number, a guidance start location, a guidance end location, a guidance start time, and a guidance end time, for example.

Cloud 40 (e.g., dispatch controller 422) predicts, based on the history information included in the robot information stored in storage 43, an area including a guidance start location, a guidance destination, and a time period for which a guidance request may occur in the future. For example, the plurality of guidance robots 10C periodically providing guidance, the history of guidance by guidance robots 10C before and after past events, and the like are known based on history information, and thus dispatch controller 422 can predict an area including a guidance start location, a guidance destination, and the time period for which a guidance request will occur in the future. Note that any existing technology may be used for the prediction method.

Cloud 40 then calculates a person shortest route, as well as a robot shortest route for each guidance robot 10C, based on the area or the like where the predicted guidance request can occur and the information on the guidance destination. Next, cloud 40 compares the person shortest route with the robot shortest route of each of guidance robots 10C, and specifies, from the plurality of guidance robots 10C, a plurality of guidance robots 10C for which the robot shortest route is the same as the person shortest route. Cloud 40 then determines whether the specified plurality of guidance robots 10C can arrive at the guidance start location at which the predicted guidance request can occur, in the time period at which the predicted guidance request can occur. If it is determined that the robots can arrive in the time period, cloud 40 generates instructions for dispatching the specified plurality of guidance robots 10C to the guidance start location, and sends the instructions to the specified plurality of guidance robots 10C. Through this, cloud 40 can determine whether the specified plurality of guidance robots 10C can be dispatched to the guidance start location at which the predicted guidance request can occur, in the time period at which the predicted guidance request can occur.

### Supplementary Note 1

The following techniques are disclosed by the descriptions in the foregoing embodiments.

### Technique 1

A control method for a robot capable of autonomous movement for guiding person to a guidance destination, the control method including: obtaining robot current location information indicating a current location of the robot; obtaining guidance destination location information indicating a location of the guidance destination; obtaining person movable area information indicating an area where the person is capable of moving; obtaining robot travelable area information indicating an area where the robot is capable of traveling; calculating a robot shortest route that is a shortest route for the robot from the current location to the location of the guidance destination, based on the robot current location information, the guidance destination location information, and the robot travelable area information obtained; calculating a person shortest route that is a shortest route for the person from the current location to the location of the guidance destination, based on the robot current location information, the guidance destination location information, and the person movable area information obtained; comparing the person shortest route calculated with the robot shortest route; and changing a display format of guidance to the guidance destination, the display format being displayed on a display of the robot, in accordance with a comparison result obtained from the comparing.

This makes it possible to recognize whether guidance is possible along the shortest route for a person.

More specifically, even if there is a non-travelable area due to the performance or the like of the guidance robot, and the person and the guidance robot have different travelable areas, the guidance robot calculates the person shortest route for the person, in addition to its own shortest route. The guidance robot then displays guidance in a display format that causes the person to recognize whether guidance is possible along the person shortest route. This makes it possible to cause the person to recognize whether they can be guided along the person shortest route, which makes it easier for the person to determine whether to have the guidance robot guide them to the guidance destination taking into account the burden on the person for walking to the guidance destination.

### Technique 2

The control method according to Technique 1, wherein when a comparison result indicating that the person shortest route and the robot shortest route are not the same is obtained, the display format displayed on the display is changed to a display format indicating that the person can be guided along the person shortest route to a midway point where the person shortest route and the robot shortest route diverge.

In this manner, the guidance robot can display, on the display of the guidance robot, an indication that guidance is possible from the current location of the person, which is also the current location of the guidance robot itself, to a midway point. Using such a display format for the guidance enables the person to determine whether to have the guidance robot guide them even if the guidance only goes midway along the route to a shop.

### Technique 3

The control method according to Technique 2, wherein when a comparison result indicating that the person shortest route and the robot shortest route are not the same is obtained, the display format displayed on the display is further changed to a display format indicating that the robot is capable of continuing to guide the person by converging with the person on a route where the person shortest route and the robot shortest route overlap again in the person shortest route.

Using such a display format for the guidance enables the person to determine whether to have the guidance robot guide them to the shop, even if there is no guidance for a predetermined distance partway along the person shortest route. If guidance is requested, the guidance robot can guide the person to the guidance destination by converging with the person again after the travel on the non-overlapping routes.

### Technique 4

The control method according to any one of Techniques 1 to 3, wherein when a comparison result indicating that the person shortest route and the robot shortest route do not match is obtained, the display format displayed on the display is further changed to a display format indicating a difference between a distance of the person shortest route and a distance of the robot shortest route in a recognizable manner.

Using such a display format for the guidance enables the person to determine whether to have the guidance robot guide them to the guidance destination, taking into account the burden of walking to the guidance destination.

### Technique 5

The control method according to any one of Techniques 2 to 4, wherein when a comparison result indicating that the person shortest route and the robot shortest route do not match is obtained, the display format displayed on the display is further changed to a display format indicating a reason why the robot shortest route does not match the robot shortest route.

Using such a display format for the guidance enables the person to determine whether to have the guidance robot guide them to the guidance destination, taking the reason into account.

### Technique 6

The control method according to Technique 1, wherein when calculating the robot shortest route, if the robot determines that travel to the location of the guidance destination is not possible based on the robot current location information, the guidance destination location information, and the robot travelable area information obtained, a shortest route between the current location and the location of the guidance destination, from the current location to a travel limit point that is a point to which the robot is capable of traveling, is calculated as the robot shortest route, and is compared, and when a comparison result indicating (i) that the robot is unable to travel to the location of the guidance destination and (ii) a boundary point, in the person shortest route, where overlap between the robot shortest route and the person shortest route ends, is obtained, the display format displayed on the display is changed to a display format indicating that the robot is capable of guiding the person from the current location to the boundary point along the person shortest route.

This enables the guidance robot to display, on the display, the reason why the robot shortest route is different from the person shortest route, in addition to the indication that the person shortest route and the robot shortest route are different.

Using such a display format for the guidance enables the person to determine whether to have the guidance robot guide them to the guidance destination, taking the reason into account.

### Technique 7

The control method according to Technique 6, wherein when a comparison result indicating (i) that the robot is unable to travel to the location of the guidance destination and (ii) the boundary point, in the person shortest route, where overlap between the robot shortest route and the person shortest route ends, is obtained, robot current location information and robot travelable area information is further obtained for each of one or more other robots different from the robot; based on the robot current location information and the robot travelable area information of each of the one or more other robots and the guidance destination location information obtained, an other robot shortest route that is a shortest route from the boundary point to the location of the guidance destination is calculated for each of the one or more other robots; an other robot having an other robot shortest route, among the other robot shortest routes, that overlaps with the person shortest route from the boundary point to the location of the guidance destination, is specified; and the display format displayed on the display is changed to a display format indicating (i) that the robot is capable of guiding the person along the person shortest route from the current location to the boundary point and (ii) that the other robot specified is capable of guiding the person from the boundary point to the location of the guidance destination.

Through this, even if the guidance robot has a travel limit point, the other guidance robot can take over the guidance, which makes it possible to display an indication that the person can be guided to the desired guidance destination for the person, along the person shortest route. Using such a display format for the guidance enables the person to determine whether to have the guidance robot and the other guidance robot to guide them to the guidance destination.

### Technique 8

The control method according to Technique 6, wherein when a comparison result indicating (i) that the robot is unable to travel to the location of the guidance destination and (ii) the boundary point, in the person shortest route, where overlap between the robot shortest route and the person shortest route ends, is obtained, robot current location information and robot travelable area information is further obtained for each of one or more other robots different from the robot; based on the robot current location information and the robot travelable area information of each of the one or more other robots and the guidance destination location information obtained, an other robot shortest route that is a shortest route from a location within a predetermined range from the boundary point to the location of the guidance destination is calculated for each of the one or more other robots; a takeover robot that is an other robot having an other robot shortest route, among the other robot shortest routes, that overlaps with the person shortest route from the location within a predetermined range from the boundary point to the location of the guidance destination, is specified; and the display format displayed on the display is changed to a display format indicating (i) that the robot is capable of guiding the person along the person shortest route from the current location to the boundary point, (ii) that the takeover robot specified is capable of guiding the person from the location within a predetermined range from the boundary point to the location of the guidance destination, and (iii) the location within a predetermined range from the boundary point as a location where the takeover robot start guidance.

Through this, even if the guidance robot has a travel limit point, the other guidance robot can take over the guidance, which makes it possible to display an indication that the person can be guided to the desired guidance destination for the person, along the person shortest route.

### Technique 9

The control method according to Technique 1, wherein when a comparison result indicating that the person shortest route and the robot shortest route do not match is obtained, robot current location information and robot travelable area information are further obtained for each of one or more other robots different from the robot; based on the robot current location information and the robot travelable area information of each of the one or more other robots and the guidance destination location information obtained, an other robot shortest route that is a shortest route from the current location to the location of the guidance destination is calculated for each of the one or more other robots; a substitute robot that is an other robot having an other robot shortest route, among the other robot shortest routes, that is the same as the person shortest route is specified; the substitute robot specified is summoned to the current location; and the display format displayed on the display is changed to a display format indicating that the substitute robot is capable of guiding the person along the person shortest route from the current location to the location of the guidance destination.

In this manner, the guidance robot can display information to the person to have the other guidance robot guide them instead. Using such a display format for the guidance enables the person to determine whether to have the other guidance robot guide them to the guidance destination instead of the guidance robot.

### Technique 10

The control method according to Technique 1, wherein when a comparison result indicating that the person shortest route and the robot shortest route do not match is obtained, robot current location information and robot travelable area information is further obtained for each of one or more other robots different from the robot; based on the robot current location information and the robot travelable area information of each of the one or more other robots and the guidance destination location information obtained, an other robot shortest route that is a shortest route to the guidance destination from a location within a predetermined range from the current location is calculated for each of the one or more other robots; a substitute robot that is present near the location within a predetermined range from the current location is specified, the substitute robot being an other robot having a robot shortest route, among the other robot shortest routes, that is the same as the person shortest route to the guidance destination from the location within a predetermined range from the current location; and the display format displayed on the display is changed to a display format indicating (i) that the substitute robot is capable of guiding the person along the person shortest route to the location of the guidance destination from the location within a predetermined range from the current location and (ii) the location within a predetermined range from the current location as the location where the substitute robot starts guidance.

In this manner, the guidance robot can display an indication that the person can be guided along the person shortest route if the person moves to the location of the other guidance robot. Using such a display format for the guidance enables the person to determine whether to have the other guidance robot guide them to the guidance destination instead of the guidance robot by moving to the location of the other guidance robot.

### Technique 11

The control method according to Technique 1, wherein when the robot is further capable of transporting a load, and a comparison result indicating that the person shortest route and the robot shortest route do not match is obtained, the display format displayed on the display is changed to a display format indicating that the robot is capable of transporting the load to the guidance destination along the robot shortest route and that the person is capable of moving to the guidance destination along the person shortest route.

In this manner, the guidance robot can present, to the person, an indication that only the load of the person can be carried along the robot shortest route, and that the person themselves can move along the person shortest route. As a result, the person can travel to the destination along the person shortest route while the guidance robot carries the load of the person to the destination along the robot shortest route, which makes it possible to increase opportunities to use the guidance robot without increasing the burden of walking on the person.

### Technique 12

The control method according to Technique 1, wherein when the robot is further capable of transporting one person, and a comparison result indicating that the person shortest route and the robot shortest route do not match is obtained, the display format displayed on the display is changed to a display format indicating that the robot is capable of transporting one person among two or more people to the guidance destination along the robot shortest route and that a person among the two or more people aside from the one person is capable of moving to the guidance destination along the person shortest route, the two or more people each being the person.

In this manner, the guidance robot can present, to a group of a plurality of people, an indication that only one person can be carried along the robot shortest route, and that the remaining people can move along the person shortest route. This makes it possible for the remaining people to travel to the destination along the person shortest route while the guidance robot carries the one person to the destination along the robot shortest route. This in turn makes it possible to eliminate the walking burden for the one person while avoiding increasing the walking burden on the remaining people, and opportunities for using the guidance robot can therefore be increased.

### Technique 13

The control method according to any one of Techniques 2 to 4, wherein when a comparison result indicating that the person shortest route and the robot shortest route do not match is obtained, the display format displayed on the display is further changed to a display format that displays an advertisement of a shop present on the person shortest route.

Through this, when viewing an advertisement displayed by the guidance robot, the person can recognize whether they can be guided to the shop that is the subject of the advertisement along a robot shortest route that is the same as the person shortest route.

### Supplementary Note 2

The following techniques are also disclosed by the descriptions in the foregoing embodiments.

### Technique 1

A control method for a robot capable of autonomous movement for guiding a person to a guidance destination, the control method including: (a) obtaining robot current location information indicating a current location of the robot; (b) obtaining guidance destination location information indicating a location of the guidance destination; (c) obtaining person movable area information indicating an area where the person is capable of moving; (d) obtaining robot travelable area information indicating an area where the robot is capable of traveling; (e) calculating a person route that is a route for the person from the current location to the location of the guidance destination, to satisfy a predetermined condition for reducing a burden on the person, based on the robot current location information, the guidance destination location information, and the person movable area information obtained; (f) comparing the person route calculated with the robot travelable area information; and (g) changing a display format of guidance to the guidance destination, the display format being displayed on a display of the robot, in accordance with a comparison result obtained from the comparing.

### Technique 2

The control method according to Technique 1, wherein (g) includes changing the display format displayed on the display to a display format indicating that the robot is capable of guiding the person to a boundary point between a region where the person route is included in the robot travelable area information and a region where the person route is not included in the robot travelable area information.

### Technique 3

The control method according to Technique 2, wherein (g) further includes changing the display format displayed on the display to a display format indicating that the robot is capable of continuing to guide the person by converging with the person at a point where the person route is again included in the robot travelable area information.

### Technique 4

The control method according to any one of Techniques 1 to 3, further including: (h) calculating a robot shortest route that is a shortest route for the robot from the current location to the location of the guidance destination, based on the robot current location information, the guidance destination location information, and the robot travelable area information obtained, wherein (e) includes calculating, as the person route, a person shortest route that is a shortest route for the person from the current location to the location of the guidance destination, (f) includes comparing the person shortest route calculated with the robot shortest route, and (g) further includes, when a comparison result indicating that the person shortest route and the robot shortest route do not match is obtained, changing the display format displayed on the display to a display format indicating a difference between a distance of the person shortest route and a distance of the robot shortest route in a recognizable manner.

### Technique 5

The control method according to Technique 2 or 3, wherein (g) further includes changing the display format displayed on the display to a display format indicating a reason why a part of the person route is not included in the robot travelable area information.

### Technique 6

The control method according to Technique 1, further including: (i) when the robot is capable of guiding the person to a boundary point between a region where the person route is included in the robot travelable area information and a region where the person route is not included in the robot travelable area information, specifying an other robot, different from the robot, capable of guiding the person along the person route from the boundary point to the location of the guidance destination, wherein (g) includes changing the display format displayed on the display to a display format indicating that the robot is capable of guidance along the person route from the current location to the boundary point, and that the other robot specified is capable of guidance from the boundary point to the location of the guidance destination.

### Technique 7

The control method according to Technique 6, further including: (j) when the robot is capable of guiding the person to the boundary point between the region where the person route is included in the robot travelable area information and the region where the person route is not included in the robot travelable area information, specifying a takeover robot that is an other robot, different from the robot, capable of guiding the person along the person route to the location of the guidance destination from a location within a predetermined range from the boundary point, wherein (g) includes changing the display format displayed on the display to a display format indicating that the robot is capable of guidance along the person route from the current location to the boundary point, and that the takeover robot specified is capable of guidance to the location of the guidance destination from the location within a predetermined range from the boundary point.

### Technique 8

The control method according to Technique 1, further including: (k) specifying a substitute robot that is an other robot, different from the robot, capable of guiding the person along an entirety of the person route, when the entirety of the person route is not included in the robot travelable area information, wherein (g) includes changing the display format displayed on the display to a display format indicating that the substitute robot is capable of guiding the person along the person route from the current location to the location of the guidance destination.

### Technique 9

The control method according to Technique 1, further including: (l) specifying a substitute robot that is an other robot, different from the robot, capable of guiding the person from a location within a predetermined range from the current location to the location of the guidance destination, when an entirety of the person route is not included in the robot travelable area information, wherein (g) includes changing the display format displayed on the display to a display format indicating that the substitute robot is capable of guiding the person along the person route from the location within a predetermined range from the current location to the location of the guidance destination.

### Technique 10

The control method according to Technique 1, further including: (m) calculating a robot route that is a route for the robot from the current location to the location of the guidance destination, based on the robot current location information, the guidance destination location information, and the robot travelable area information obtained, wherein the robot is further capable of transporting a load, and (g) includes changing the display format displayed on the display to a display format indicating that the robot is capable of transporting the load to the guidance destination along the robot route and that the person is capable of moving to the guidance destination along the person route.

### Technique 11

The control method according to Technique 1, further including: (n) calculating a robot route that is a route for the robot from the current location to the location of the guidance destination, based on the robot current location information, the guidance destination location information, and the robot travelable area information obtained, wherein the robot is further capable of transporting one person, and (g) includes changing the display format displayed on the display to a display format indicating that the robot is capable of transporting the one person among two or more people to the guidance destination along the robot route, and that a person among the two or more people and aside from the one person is capable of moving to the guidance destination along the person route, the two or more people each being the person.

### Technique 12

The control method according to any one of Techniques 1 to 3, wherein (g) further includes changing the display format displayed on the display to a display format that displays an advertisement of a shop present on the person route.

### Technique 13

A robot capable of autonomous movement for guiding person to a guidance destination, the robot including: an obtainer that obtains robot current location information indicating a current location of the robot, guidance destination location information indicating a location of the guidance destination, person movable area information indicating an area where the person is capable of moving, and robot travelable area information indicating an area where the robot is capable of traveling; a calculator that calculates a person route that is a route for the person from the current location to the location of the guidance destination, to satisfy a predetermined condition for reducing a burden on the person, based on the robot current location information, the guidance destination location information, and the person movable area information obtained; a comparison processor that compares the person route calculated with the robot travelable area information; and a display controller that changes a display format of guidance to the guidance destination, displayed on a display of the robot, in accordance with a comparison result obtained from the comparing.

### Technique 14

A non-transitory computer-readable recording medium having recorded thereon a program for controlling a robot capable of autonomous movement for guiding person to a guidance destination, the program causing a computer to execute: obtaining robot current location information indicating a current location of the robot; obtaining guidance destination location information indicating a location of the guidance destination; obtaining person movable area information indicating an area where the person is capable of moving; obtaining robot travelable area information indicating an area where the robot is capable of traveling; calculating a person route that is a route for the person from the current location to the location of the guidance destination, to satisfy a predetermined condition for reducing a burden on the person, based on the robot current location information, the guidance destination location information, and the person movable area information obtained; comparing the person route calculated with the robot travelable area information; and changing a display format of guidance to the guidance destination, displayed on a display of the robot, in accordance with a comparison result obtained from the comparing.

### Other Embodiments, Etc

A control method and the like according to one or more aspects have been described thus far based on embodiments, but the present disclosure is not limited to the embodiments and modified examples.

Various conceivable variations made on the embodiments and modified examples by one skilled in the art also fall within the scope of the present disclosure as long as those variations do not depart from the essential spirit of the present disclosure.

In the foregoing embodiments, the constituent elements are constituted by dedicated hardware. However, the constituent elements may be realized by executing software programs corresponding to those constituent elements. Each constituent element may be realized by a program executing unit such as a CPU or a processor reading out and executing a software program recorded on a recording medium such as a hard disk or semiconductor memory.

Note that the present disclosure is also inclusive of the following cases.

(1) At least one of the above-described devices is specifically a computer system constituted by a microprocessor, ROM, RAM, a hard disk unit, a display unit, a keyboard, a mouse, and the like. A computer program is stored in the RAM or hard disk unit. The at least one of the above-described devices realizes the functions thereof by the microprocessor operating in accordance with the computer program. Here, the computer program is constituted by a combination of a plurality of command codes that indicate commands made to a computer to achieve a predetermined function.

(2) Some or all of the constituent elements constituting at least one of the above-described devices may be constituted by a single system LSI (Large Scale Integration) circuit. “System LSI” refers to very-large-scale integration in which multiple constituent elements are integrated on a single chip, and specifically, refers to a computer system configured including a microprocessor, ROM, RAM, and the like. A computer program is stored in the RAM. The system LSI circuit realizes the functions thereof by the microprocessor operating in accordance with the computer program.

(3) Some or all of the constituent elements constituting at least one of the above-described devices may be constituted by IC cards or stand-alone modules that can be removed from and mounted in the device. The IC card or module is a computer system constituted by a microprocessor, ROM, RAM, and the like. The IC card or module may include the above very-large-scale integration LSI circuit. The IC card or module realizes the functions thereof by the microprocessor operating in accordance with the computer program. The IC card or module may be tamper-resistant.

(4) The present disclosure may be realized by the methods described above. This may be a computer program that implements these methods on a computer, or a digital signal constituting the computer program.

Additionally, the present disclosure may also be computer programs or digital signals recorded in a computer-readable recording medium such as a flexible disk, a hard disk, a Compact Disc (CD)-ROM, a DVD, a DVD-ROM, a DVD-RAM, a Blu-ray (registered trademark) Disc (BD), semiconductor memory, or the like. The constituent elements may also be the digital signals recorded in such a recording medium.

Additionally, the present disclosure may be realized by transmitting the computer program or digital signal via a telecommunication line, a wireless or wired communication line, a network such as the Internet, a data broadcast, or the like.

Additionally, the present disclosure may be implemented by another independent computer system, by recording the program or the digital signal in the recording medium and transferring the recording medium, or by transferring the program or the digital signal over the network or the like.

### INDUSTRIAL APPLICABILITY

The present disclosure can be used in control methods, guidance robots, and the like that make it possible to recognize whether a guidance robot is capable of guiding a person along a shortest route to a destination such as a shop in a shopping mall, an event venue, a station, or an amusement park, for example.

1. A control method for a robot capable of autonomous movement for guiding a person to a guidance destination, the control method comprising:
(a) obtaining robot current location information indicating a current location of the robot;
(b) obtaining guidance destination location information indicating a location of the guidance destination;
(c) obtaining person movable area information indicating an area where the person is capable of moving;
(d) obtaining robot travelable area information indicating an area where the robot is capable of traveling;
(e) calculating a person route that is a route for the person from the current location to the location of the guidance destination, to satisfy a predetermined condition for reducing a burden on the person, based on the robot current location information, the guidance destination location information, and the person movable area information obtained;
(f) comparing the person route calculated with the robot travelable area information; and
(g) changing a display format of guidance to the guidance destination, the display format being displayed on a display of the robot, in accordance with a comparison result obtained from the comparing.

2. The control method according to claim 1,
wherein (g) includes changing the display format displayed on the display to a display format indicating that the robot is capable of guiding the person to a boundary point between a region where the person route is included in the robot travelable area information and a region where the person route is not included in the robot travelable area information.

3. The control method according to claim 2,
wherein (g) further includes changing the display format displayed on the display to a display format indicating that the robot is capable of continuing to guide the person by converging with the person at a point where the person route is again included in the robot travelable area information.

4. The control method according to claim 1, further comprising:
(h) calculating a robot shortest route that is a shortest route for the robot from the current location to the location of the guidance destination, based on the robot current location information, the guidance destination location information, and the robot travelable area information obtained,
wherein (e) includes calculating, as the person route, a person shortest route that is a shortest route for the person from the current location to the location of the guidance destination,
(f) includes comparing the person shortest route calculated with the robot shortest route, and
(g) further includes, when a comparison result indicating that the person shortest route and the robot shortest route do not match is obtained, changing the display format displayed on the display to a display format indicating a difference between a distance of the person shortest route and a distance of the robot shortest route in a recognizable manner.

5. The control method according to claim 2,
wherein (g) further includes changing the display format displayed on the display to a display format indicating a reason why a part of the person route is not included in the robot travelable area information.

6. The control method according to claim 1, further comprising:
(i) when the robot is capable of guiding the person to a boundary point between a region where the person route is included in the robot travelable area information and a region where the person route is not included in the robot travelable area information, specifying an other robot, different from the robot, capable of guiding the person along the person route from the boundary point to the location of the guidance destination,
wherein (g) includes changing the display format displayed on the display to a display format indicating that the robot is capable of guidance along the person route from the current location to the boundary point, and that the other robot specified is capable of guidance from the boundary point to the location of the guidance destination.

7. The control method according to claim 6, further comprising:
(j) when the robot is capable of guiding the person to the boundary point between the region where the person route is included in the robot travelable area information and the region where the person route is not included in the robot travelable area information, specifying a takeover robot that is an other robot, different from the robot, capable of guiding the person along the person route to the location of the guidance destination from a location within a predetermined range from the boundary point,
wherein (g) includes changing the display format displayed on the display to a display format indicating that the robot is capable of guidance along the person route from the current location to the boundary point, and that the takeover robot specified is capable of guidance to the location of the guidance destination from the location within a predetermined range from the boundary point.

8. The control method according to claim 1, further comprising:
(k) specifying a substitute robot that is an other robot, different from the robot, capable of guiding the person along an entirety of the person route, when the entirety of the person route is not included in the robot travelable area information,
wherein (g) includes changing the display format displayed on the display to a display format indicating that the substitute robot is capable of guiding the person along the person route from the current location to the location of the guidance destination.

9. The control method according to claim 1, further comprising:
(l) specifying a substitute robot that is an other robot, different from the robot, capable of guiding the person from a location within a predetermined range from the current location to the location of the guidance destination, when an entirety of the person route is not included in the robot travelable area information,
wherein (g) includes changing the display format displayed on the display to a display format indicating that the substitute robot is capable of guiding the person along the person route from the location within a predetermined range from the current location to the location of the guidance destination.

10. The control method according to claim 1, further comprising:
(m) calculating a robot route that is a route for the robot from the current location to the location of the guidance destination, based on the robot current location information, the guidance destination location information, and the robot travelable area information obtained,
wherein the robot is further capable of transporting a load, and
(g) includes changing the display format displayed on the display to a display format indicating that the robot is capable of transporting the load to the guidance destination along the robot route and that the person is capable of moving to the guidance destination along the person route.

11. The control method according to claim 1, further comprising:
(n) calculating a robot route that is a route for the robot from the current location to the location of the guidance destination, based on the robot current location information, the guidance destination location information, and the robot travelable area information obtained,
wherein the robot is further capable of transporting one person, and
(g) includes changing the display format displayed on the display to a display format indicating that the robot is capable of transporting the one person among two or more people to the guidance destination along the robot route, and that a person among the two or more people and aside from the one person is capable of moving to the guidance destination along the person route, the two or more people each being the person.

12. The control method according to claim 1,
wherein (g) further includes changing the display format displayed on the display to a display format that displays an advertisement of a shop present on the person route.

13. A robot capable of autonomous movement for guiding person to a guidance destination, the robot comprising:
an obtainer that obtains robot current location information indicating a current location of the robot, guidance destination location information indicating a location of the guidance destination, person movable area information indicating an area where the person is capable of moving, and robot travelable area information indicating an area where the robot is capable of traveling;
a calculator that calculates a person route that is a route for the person from the current location to the location of the guidance destination, to satisfy a predetermined condition for reducing a burden on the person, based on the robot current location information, the guidance destination location information, and the person movable area information obtained;
a comparison processor that compares the person route calculated with the robot travelable area information; and
a display controller that changes a display format of guidance to the guidance destination, displayed on a display of the robot, in accordance with a comparison result obtained from the comparing.

14. A non-transitory computer-readable recording medium having recorded thereon a program for controlling a robot capable of autonomous movement for guiding person to a guidance destination, the program causing a computer to execute:
obtaining robot current location information indicating a current location of the robot;
obtaining guidance destination location information indicating a location of the guidance destination;
obtaining person movable area information indicating an area where the person is capable of moving;
obtaining robot travelable area information indicating an area where the robot is capable of traveling;
calculating a person route that is a route for the person from the current location to the location of the guidance destination, to satisfy a predetermined condition for reducing a burden on the person, based on the robot current location information, the guidance destination location information, and the person movable area information obtained;
comparing the person route calculated with the robot travelable area information; and
changing a display format of guidance to the guidance destination, displayed on a display of the robot, in accordance with a comparison result obtained from the comparing.
